(19) United States
(12) Patent Application Publication
(10) Pub. No.: US 2003/0001949 A1
(43) Pub. Date: Jan. 2, 2003

(54) Picture file device

(75) Inventors: Mitsuo Obata, Tokyo (JP); Tomoyasu Kawai, Nanuet, NY (US)

Correspondence Address: Paul J. Esatto, Jr., Scully, Scott, Murphy & Presser, 400 Garden City Plaza, Garden City, NY, 11530, US

(73) Assignee: OLYMPUS OPTICAL CO., LTD., TOKYO (JP)

(21) Appl. No.: 10/174,001

(22) Filed: Jun. 18, 2002

(30) Foreign Application Priority Data
Jun. 20, 2001 (JP) 2001-186950

(51) Int. Cl. H04N 7/18

(52) U.S. Cl. 348/61; 386/46

(57) ABSTRACT

A picture file device having a memory device for recording a still picture has a communication interface circuit for outputting a control signal to a function unit based on a control signal received by the communication interface circuit. The picture file device further includes a picture recording control circuit for, when a picture recording operation is detected, creating a picture file having a first area for storing data of the still picture and a second area for storing first text data relating to the still picture data and for outputting the created picture file to the memory device.

This application claims benefit of Japanese Application No. 2001-186950 filed on Jun. 20, 2001, the contents of which are incorporated by this reference.

### BACKGROUND OF THE INVENTION

1. Field of the Invention

The present invention relates to a picture file device for recording a picture shot by, for example, an endoscope, on a recording medium in order to allow the readout and the observation of the recorded picture as necessary.

2. Description of the Related Art

A picture file device, which records many pictures on a recording medium in order to allow the readout and the observation of the recorded pictures as necessary, is used for recording pictures shot by, for example, an endoscope device, for examinations and diagnoses.

By the way, an endoscope picture file device of the related art records pictures in picture formats, which depend on devices.

Furthermore, the endoscope picture file device of the related art manages pictures in picture managing tables, whose formats depend on devices.

Therefore, when a picture recorded in one type of endoscope picture file device is read by another type of endoscope picture file device, the picture format and the picture managing table need to be converted to those of the type of the reading endoscope picture file device. In the related art, this is disclosed in, for example, Japanese Unexamined Patent Application Publication No. 8-336160 filed by the present applicant.

According to the publication, a picture file format and a format of a picture managing table of a picture recorded by one endoscope device are converted into those of a reading picture file device in order to achieve the communication and/or copy of the picture.

Recently, personal computers, digital still cameras and other peripheral equipment have been widely spread. Accordingly, needs have been raised for causing them to read data from a recording medium on which pictures recorded by an endoscope picture file device, to playback the picture by using user's digital still camera and/or to print it by using a printer for a digital camera.

Therefore, the picture format for pictures recorded by the endoscope picture file device and the picture managing methods become based on digital still camera standards. The digital still camera standards include the picture file format standard for digital still cameras (called Exif hereinafter) in the JEIDA standard. Further, the standards include the camera file system standard (called DCF hereinafter) in the JEIDA standard for the purpose of easy exchanges of picture files based on the Exif specification.

With the picture management based on the DCF standard, pictures are stored in multiple directories called “DCF directories”.

The DCF directory name must include a three-digit directory number and free-characters including an arbitrary five-letter string, which follows the directory number. For example, the name will be 100ABCDE.

Further, a picture file is managed under the picture file name in accordance with the DCF file name rule.

The DCF file name includes free-characters including an arbitrary four-letter string and a four-digit file number, which follows the free characters. The extension must be JPG. For example, the name will be ABCD0001.JPG.

Departing from these rules, digital cameras and the peripherals cannot recognize files in the recording medium. Thus, the reproduction and/or the printing of the pictures cannot be achieved by the apparatuses such as the digital cameras.

On the other hand, the subjects of endoscope devices may be the inside of the pipe and turbine blades within a jet engine, etc. These pictures may be similar.

For example, in an example of the turbine blades within the jet engine, there are provided a number of turbine blades, which have a similar form, on the turbine. Furthermore, a number of turbines are provided within the jet engine. When pictures of these subjects are recorded by the endoscope picture file device, the titles and comments are generally recorded along with the pictures.

Conventionally, as disclosed in the Japanese Unexamined Patent Application Publication No. 2000-222417 (Japanese Patent Application No. 11-022243), text data in input from a keyboard for each picture and is recorded as a text data file. Then, the mapping information for the picture file and the text data file is recorded in the index information file.

However, when the subject is a number of folds of turbine blade provided in the jet engine, the pictures need to be recorded by specifying the types of engine, turbine and blade.

Accordingly, for a picture based on the DCF standard, the title of the picture can be recorded in the picture file.

However, when a number of blades are provided on each turbine in the jet engine, and furthermore, when there are a number of such turbines therein, it is time-consuming to add titles to pictures.

For example, when titles such as “1st. BLADE” and “2nd. BLADE”, it consumes a few minutes to input “1st.” and “2nd.” from a keyboard.

Furthermore, the Japanese Unexamined Patent Application Publication No. 8-336160 filed by the present applicant discloses an embodiment where still pictures are aligned and are displayed. In that embodiment, since the still pictures must be aligned and be displayed, the pictures must be recorded once.

Even when a still picture, which is previously recorded, is aligned and is displayed along with a live picture, both pictures cannot be displayed in full-size at the same time. Accordingly, each of portions of the aligned and displayed live picture and still picture on the same screen needs to be selected.

However, conventionally, when a desired portion is selected, either live picture or still picture must be selected in advance for selecting the portion. In other words, portions of the live picture and the still picture cannot be selected simultaneously.

### SUMMARY OF THE INVENTION

The present invention was made in view of the above problems. It is an object of the present invention to provide a picture file device, which can reproduce a picture by using a commercially available digital camera, can print the picture by using peripheral terminals such as a printer for the digital camera, can manage pictures easily, and can easily add titles to pictures of multiple subjects, which are similar in form.

It is another object of the present invention to provide a picture file device which can display a live picture, that is, a current picture along with the display of the recorded past picture in order to compare the past picture and the current picture and to easily observe a desired portion of the subject.

It is another object of the present invention to provide a picture file device, which can display the current picture and the past picture in alignment and can easily select a portion of the pictures.

According to the present invention, there is provided a picture file device, having: recording means for recording a still picture, including control means having communication means for outputting a control signal to a function unit based on a control signal received by the communication means; recording operation detecting means for detecting a picture recording operation; and picture recording control means for, when the picture recording operation is detected by the recording operation detecting means, creating a picture file having a first area for storing data of the still picture and a second area for storing first text data relating to the still picture data and for outputting the created picture file to the recording means.

In this case, the picture file device further includes: comparison display means for displaying simultaneously a first picture indicating a current state of a subject and a second picture indicating a past state of the subject, which is read from the picture recording means, in alignment at the same time by switching picture switching means, and a displayed area changing means for independently changing displayed area of the first picture and the second picture, which are displayed in the display means.

The above and other objects, features and advantages of the invention will become more clearly understood from the following description referring to the accompanying drawings.

### BRIEF DESCRIPTION OF THE DRAWINGS

FIG. 1 is a block diagram of the hardware configuration of a picture file device according to a first embodiment of the present invention;

FIG. 2 is a block diagram of the functional configuration of a video signal processing circuit and a voice signal processing circuit according to the first embodiment;

FIG. 3 is a perspective view showing an appearance of a remote controller according to the first embodiment;

FIG. 4 shows a screen for describing a live picture according to the first embodiment;

FIG. 5 shows a diagram showing a screen for describing a live picture having a menu according to the first embodiment;

FIG. 6 shows a screen for describing a picture title entering window according to the first embodiment;

FIG. 7 is a flowchart showing a flow of processing for entering a picture title according to the first embodiment;

FIG. 8 shows a screen for describing a directory title entering window according to the first embodiment;

FIG. 9 is a block diagram showing the functional configuration of a system control portion according to the first embodiment;

FIG. 10 is a block diagram showing the configuration of an operation detecting portion according to the first embodiment;

FIG. 11 is a block diagram showing the configuration of a still picture data recording control portion according to the first embodiment;

FIG. 12 is a block diagram showing the configuration of a still picture data output control portion according to the first embodiment;

FIG. 13 is a flowchart showing a flow of processing for entering a directory title according to the first embodiment;

FIG. 14 is a flowchart showing a flow of processing for recording a directory title recording file according to the first embodiment;

FIG. 15 is a flowchart showing a flow of processing for recording a still picture data according to the first embodiment;

FIG. 16 is a flowchart showing a flow of processing for displaying a thumbnail picture according to the first embodiment;

FIG. 17 is a diagram for explaining data within a PC card according to the first embodiment;

FIG. 18 is a diagram for explaining a directory title recording file according to the first embodiment;

FIG. 19 is a diagram for explaining details of a picture file according to the first embodiment;

FIG. 20 is a diagram showing a screen for explaining a thumbnail screen according to the first embodiment;

FIG. 21 is a diagram showing a reproduction screen having a menu according to the first embodiment;

FIG. 22 is a diagram showing a comparison screen according to the first embodiment;

FIG. 23 is a diagram showing the configuration of a superimpose portion according to the first embodiment;

FIG. 24 is a flowchart showing a flow for controlling the superimpose control portion according to the first embodiment;

FIG. 25 is a diagram for explaining data within a PC card according to a second embodiment of the present invention;

FIG. 26 is a diagram for describing the configuration of a control command according to the first embodiment;

FIG. 27 is a diagram for describing details of a picture file according to the second embodiment;

FIG. 28 is a block diagram for showing the configuration of a still picture data recording control portion according to the second embodiment;

FIG. 29 is a flowchart showing a flow of processing for recording still picture data according to the second embodiment; and

FIG. 30 is a flowchart showing a flow of processing for displaying a thumbnail picture according to the second embodiment.

### DETAILED DESCRIPTION OF THE PREFERRED EMBODIMENTS

Embodiments of the present invention will be described with reference to accompanying drawings.

First Embodiment

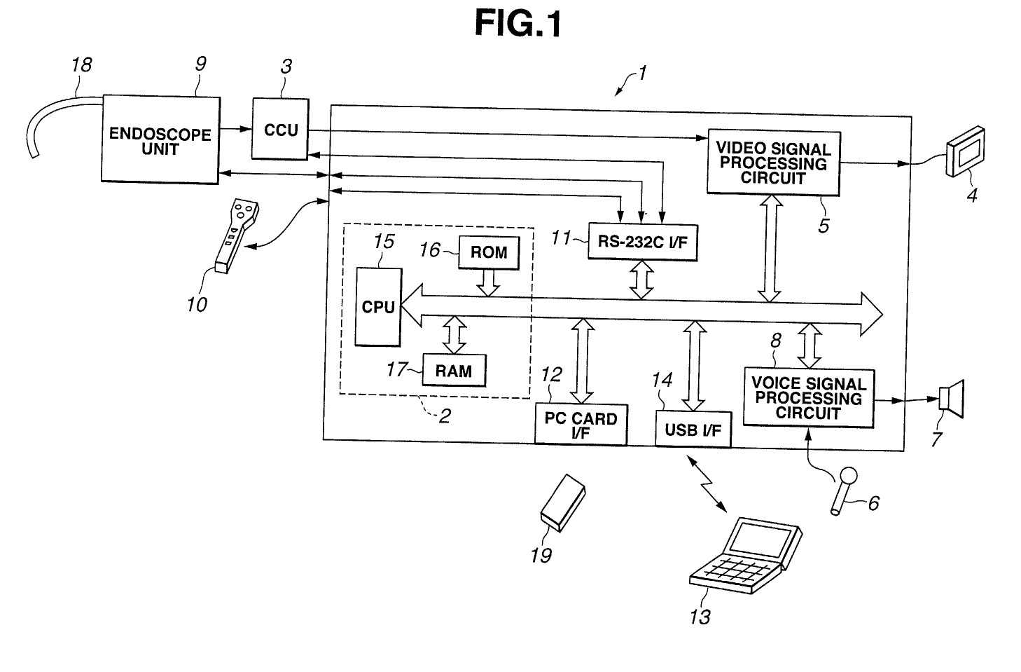

FIG. 1 is a block diagram showing an endoscope picture file device according to a first embodiment of the present invention.

An endoscope picture file device 1 according to this embodiment includes a system control unit 2, a video signal processing circuit 5, a voice signal processing circuit 8, an RS-232C interface (abbreviated as “I/F” hereinafter) 11, a PC card I/F 12, and a USB I/F 14.

The system control unit 2 controls operations of the picture file device 1.

The video signal processing circuit 5 has a function as an interface (called “I/F” hereinafter) for inputting video signals from a camera control unit (called “CCU” hereinafter) 3, which converts signals from an endoscope unit 9 to video signals and for outputting the video signals to a video output device 4.

The voice signal processing circuit 8 has a function as an I/F for inputting voice signals from a voice signal input device 6 and for outputting the voice signals to a voice output device 7.

The RS-232C I/F 11 controls the endoscope unit 9, the CCU 3 and a remote controller 10 by using serial signals.

While the communication among the endoscope picture file device 1, the endoscope unit 9, the CCU 3 and the remote controller 10 may be serial (for example, RS-232C, USB and IEEE 1394) or parallel, the serial communication (RS-232C) is applied in this embodiment.

This communication is performed based on “communication rules” described below.

The PC card I/F 12 records, on the PC card 19, picture data in which video signals from the CCU 3 are A/D converted and are compressed and voice data in which voice signals from the voice signal input device 6 are A/D converted. Then, the PC card I/F 12 reads out the picture data and the voice data recorded in the PC card 19.

The USB I/F 14 is connected with a personal computer (abbreviated as “PC” hereinafter) 13. The PC 13 remotely controls the endoscope picture file device 1, the CCU 3 and the endoscope unit 9. Furthermore, the USB I/F 14 can be an I/F used for transferring picture data and the voice data from/to the endoscope picture file device 1.

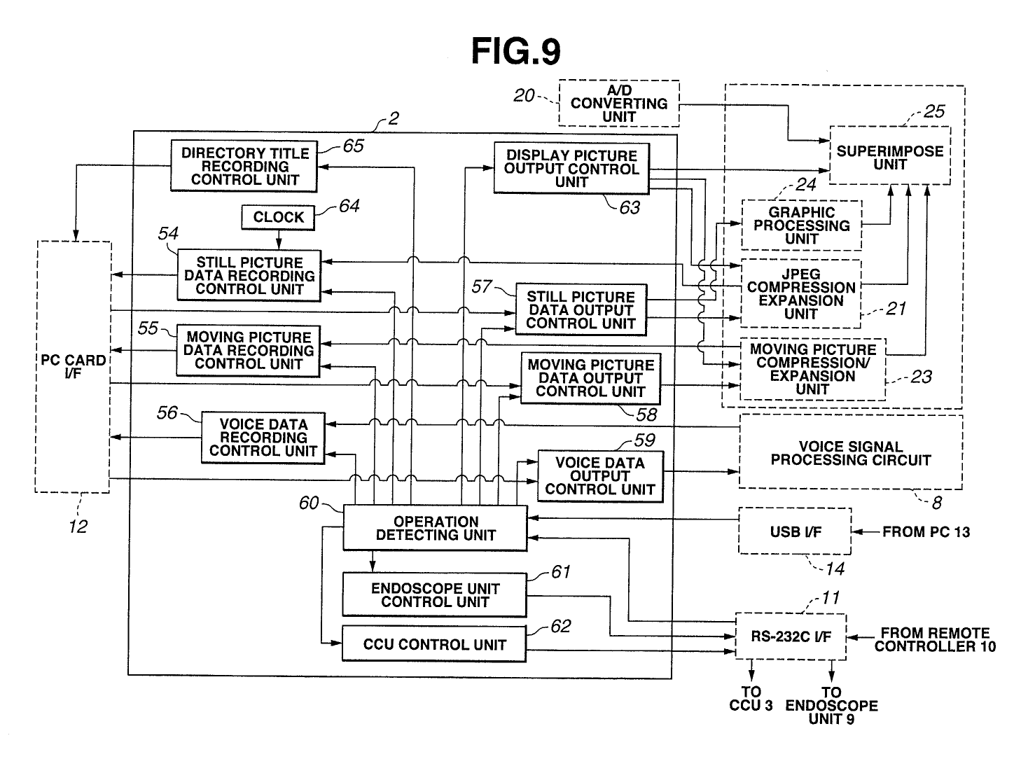

The above system control unit 2 physically includes a CPU 15 for controlling the picture file device 1, a ROM 16 for storing a system control program to be executed by the CPU 15, and a RAM 17 for storing programs to be executed by the CPU 15 and/or for obtaining a work area for the CPU 15. The functional configuration of the system control unit 2 will be described later in FIG. 9.

The endoscope unit 9 is provided with an endoscope inserting unit 18 and is further provided with a light source, not shown, inside. The endoscope inserting unit 18 is inserted into a subject in order to photograph the inside by using an image pickup element provided within, for example, the distal portion of the endoscope inserting unit 18.

The PC card 19 as recording means can be inserted into the PC card I/F 12. Data can be read from and/or written in the inserted PC card 19.

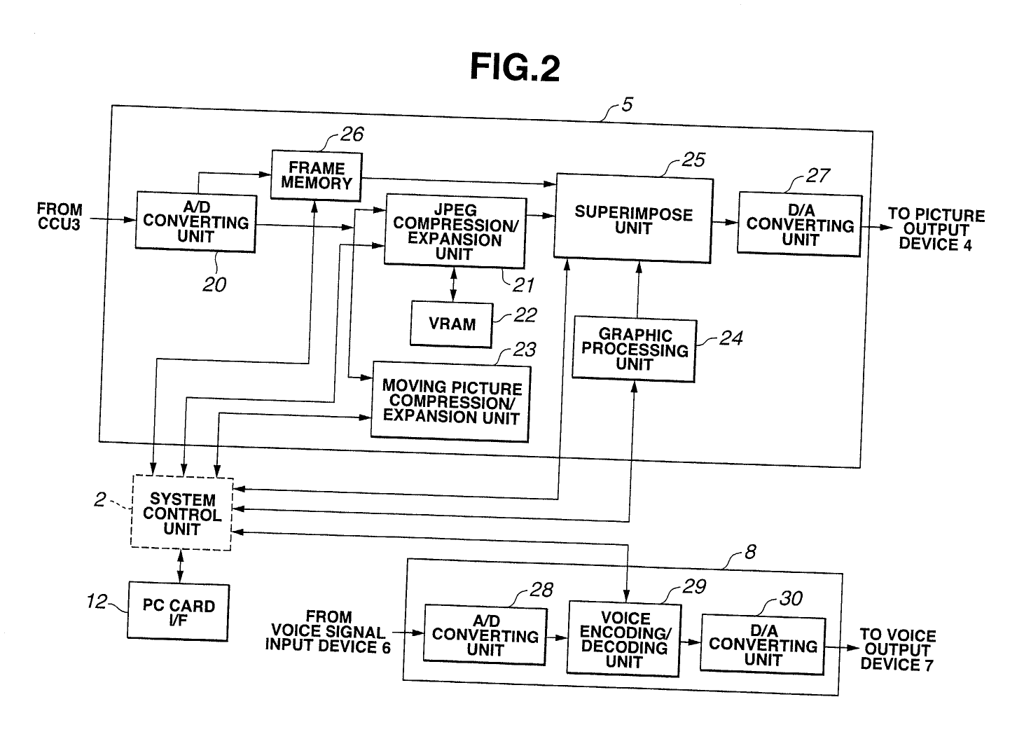

FIG. 2 shows the configurations of the video signal processing circuit 5 and the voice signal processing circuit 8 in FIG. 1.

As shown in FIG. 2, the video signal processing circuit 5 includes an A/D converting unit 20, a JPEG compression/expansion unit 21, a VRAM 22, a moving picture compression/expansion unit 23, a frame memory 26, a graphic processing unit 24, a superimpose unit 25 and a D/A converting unit 27.

The A/D converting unit 20 A/D-converts video signals from the CCU 3. The frame memory 26 temporally stores the A/D converted video data. The JPEG compression/expansion unit 21 compresses/expands still picture data. The VRAM 22 temporally stores the picture data compressed or expanded by the JPEG compression/expansion unit 21. The moving picture compression/expansion unit 23 compresses/expands moving picture data. The graphic processing unit 24 creates graphic data.

The superimpose unit 25 superimposes video data digitally converted by the A/D converting unit 20 or video data from the JPEG compression/expansion unit 21 or the moving picture compression/expansion unit 23 and graphic data created by the graphic processing unit 24. The D/A converting unit 27 D/A converts video data from the superimpose unit 25.

The voice signal processing circuit 8 includes an A/D obverting unit 28 for A/D-converting voice signals from the voice signal input device 6, a voice encoding/decoding unit 29 for encoding/decoding the digital voice signals, and a D/A converting unit 30 for D/A converting decoded digital voice signals.

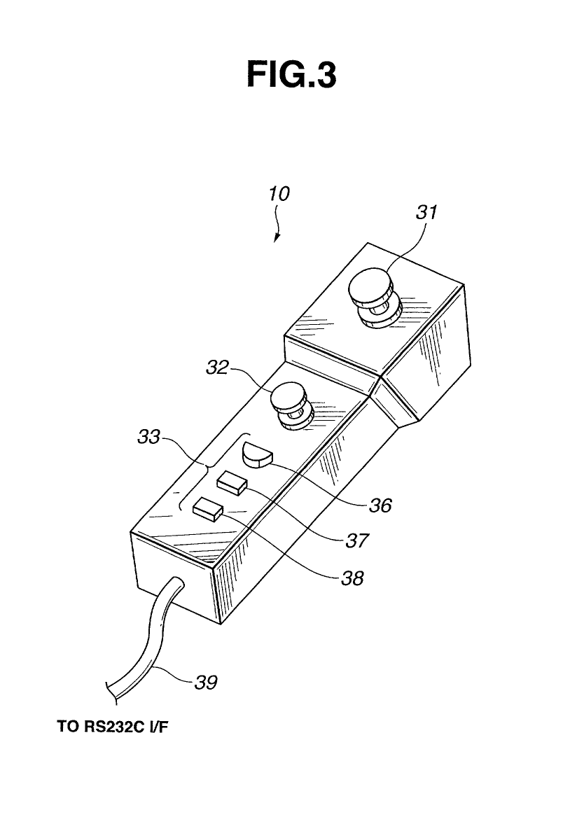

FIG. 3 is a perspective view showing an appearance of the remote controller 10 in FIG. 1.

As shown in FIG. 3, the remote controller 10 is connected to the RS-232C I/F 11 of the picture file device 1 through a remote controller cable 39. Multiple switches are provided in the remote controller 10.

The remote controller 10 has a joystick 31, a lever switch 32 and a push switch group 33.

When the joystick 31 is inclined to an arbitrary direction, inclined angle information can be output. When the joystick 31 is pressed to the center axis direction, the press information can be output.

When the lever switch 32 is inclined to the horizontal or vertical directions, the horizontal or inclined angle information can be output. When the lever switch 32 is pressed to the center axis direction, the press information can be output.

The push switch group 33 outputs press information when pressed. The push switch group 33 has multiple switches such as a freeze switch 36, a zoom switch 37 and a store switch 38.

The respective pieces of press information for the switches 36, 37 and 38 in the push switch group 33 are assigned to the respective functions.

Control signals of inclination information and press information from the remote controller 10 are input to the CPU 15 through the RS-232C I/F 11. The CPU 15 controls the picture file device 1 in accordance with the system control program.

Now, communication rules used for communication among units will be described.

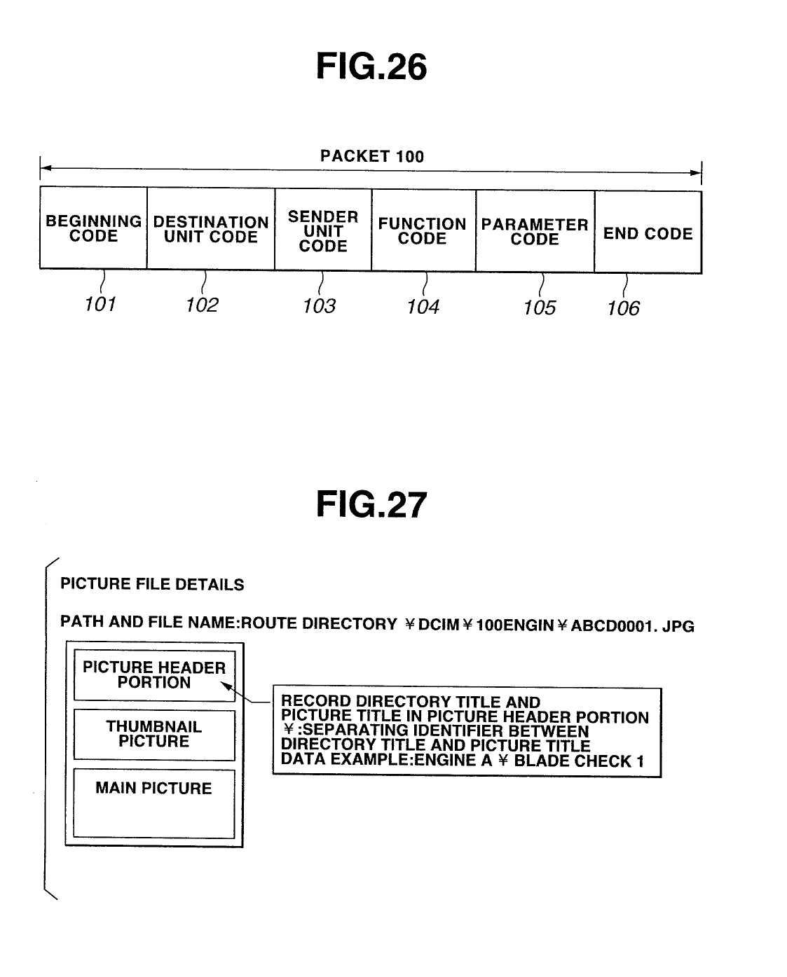

As shown in FIG. 26, a control command based on the communication rules passes through a serial transmission line in form of one packet 100. The packet 100 includes a beginning code 101, a receiver unit code 102, a sender unit code 103, function code 104, a parameter code 105 and an end code 106.

Table 1 shows types of code and descriptions of the
respective functions.

| CODE TYPE | FUNCTION DESCRIPTION |
|---|---|
| BEGINNING CODE | code indicating the beginning of the |
| | packet |
| | (X: command and Y: command response) |
| RECEIVER UNIT CODE | code indicating command receiver unit |
| SENDER UNIT CODE | code indicating command sender unit |
| FUNCTION CODE | code to be controlled for respective |
| | functions |
| PARAMETER CODE | parameter code for a function to be |
| | controlled |
| END CODE | code indicating the end of the packet |

(1) The beginning code 101 is a code for indicating the beginning of the packet 100. For example, “X” indicates a command and “Y” indicates a command response.

(2) The receiver unit code 102 is a code indicating a command receiving unit.

(3) The sender unit code 103 is a code indicating command sending unit.

(4) The function code 104 indicates a code to be controlled for each function.

(5) The parameter code 105 indicates parameter values of functions to be controlled.

(6) The end code 106 is a code for indicating the end of the packet 100.

By using communication rules based on the above command forms, the control information and response checking information are transmitted to the serial communication line.

The unit corresponding to the receiver unit code 102 determines the control information sent to itself and decodes code, which is assigned to the function code 104, to be controlled. Then, the unit selects the control mode and set a parameter value for each function specified by the parameter code 105.

“Y” can be added to the beginning code of the query command sent in order to make sure that communication control has been performed.

For example, when the joystick 31 of the remote controller 10 is inclined to an arbitrary direction, the control signal is input to the CPU 15 through the RS-232C I/F 11 in accordance with communication rules based on the above command form. The CPU 15 sends the angle control signal to the pointed end of the endoscope inserting portion 18 to the endoscope unit 9 through the RS-232C I/F 11, similarly in accordance with the communication rules based on the above command form. The endoscope unit 9 includes a motor, not shown, inside. The angle operation wire within the endoscope inserting portion 18 is extracted or extended so as to control the angle of the pointed end of the endoscope inserting portion 18.

When the joystick 31 is pressed down to the center axis direction, the control signal is similarly input to the CPU 15. Then, the CPU 15 sends the angle lock signal of the pointed end of the endoscope inserting portion 18 to the endoscope unit 9 through the RS-232C I/F 11. The endoscope unit 9 stops the motor so as to fix the angle of the pointed end of the endoscope inserting portion 18.

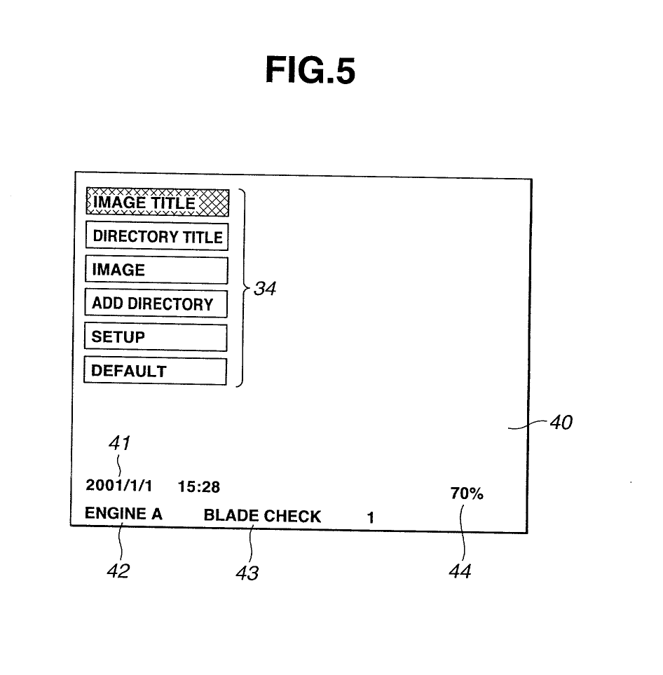

When the lever switch 32 of the remote controller 10 is inclined to four directions horizontally and vertically and is pressed down to the lever center axis direction, the control signal is input to the CPU 15 through the RS-232C I/F 11. When the control signal indicates the inclination to the horizontal and vertical four directions, the CPU 15 performs menu selecting processing in accordance with the system control program. Then, the CPU 15 sends the menu selection operation signal to the graphic processing unit 24. The graphic processing unit 24 displays a menu icon 34, as shown in the live screen having a menu in FIG. 5, on a screen of the video output device 4. There, the selected icon is highlighted.

The CPU 15 displays the menu when any menu has not been displayed or performs menu designation processing and executes a designated function if any menu is being displayed.

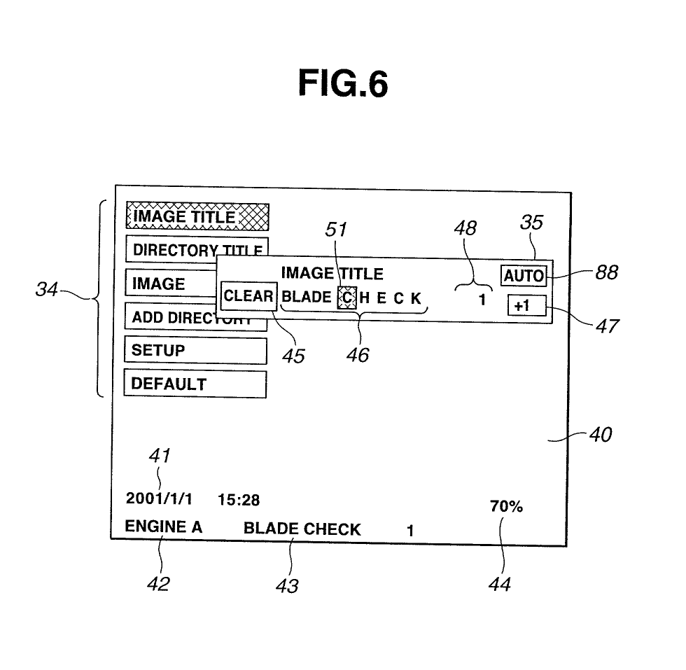

The CPU 15 sends, to the graphic processing unit 24, graphic creating signals generated along with the menu designation processing. The graphic processing unit 24 displays a window, as shown by a picture title input window 35 in FIG. 6, on the screen of the video output device 4. This is a function for adding a title to the picture to be recorded.

The menu includes a DIRECTORY TITLE function for adding a title to a directory for recording pictures, a picture function for controlling video signals from the CCU 3, an ADD DIRECTORY function for adding a directory for recording pictures, a SETUP function for executing settings for the picture file device 1, a DEFAULT function for initializing the function set on the menu and a COMPARE function for displaying a live picture and a still picture, which has been recorded in the PC card 19, in alignment.

When the lever switch 32 of the remote controller 10 is inclined to select the PICTURE function and then the lever switch 32 is pressed down to the center axis direction for the designation, a submenu of the PICTURE menu is displayed.

Functions in the submenu includes ON/OFF of, for example, the automatic gain control (AGC) and a function for setting a light measuring condition.

Similarly, the submenu of the SETUP function includes an ADJUST DATE for setting a date of the picture file device 1, and an AUDIO OUT function for controlling ON/OFF of the voice output from the voice signal processing circuit 8.

When each of the switches in the push switch group 33 of the remote controller 10 is pressed down, the control signal is input to the CPU 15 through the RS-232C I/F 11.

The CPU 15 receives the control signal owned by each hot key and executes the corresponding processing in accordance with the system control program.

For example, when a freeze switch 36 is pressed down, the system control unit 2 temporally stores, in the frame memory 26, video data, which is digitized by the A/D converting unit 20 of the video signal processing circuit 5. Then, the system control unit 2 reads out the video data stored in the frame memory 26 and superimposes the read video data with the graphic data in the superimpose unit 25. Then, the superimpose unit 25 outputs the result to the video output device 4 through the D/A converting unit 27. In this case, by inhibiting writing data in the frame memory 26, the video data before the inhibition is read from the frame memory 26, and the same video data is repeatedly read out. In other words, a still picture (freeze picture) is displayed.

Again, when the freeze switch 36 is pressed down, the inhibition of data writing in the frame memory 26 is released. Then, the system control unit 2 superimposes video data, which is digitized by the A/D converting unit 20 of the video signal processing circuit 5, on the graphic data in the superimpose unit 25 through the frame memory 26. Then, the result is output from the video output device 4 through the D/A converting unit 27. By permitting data writing in the frame memory 26, video data for live pictures (moving pictures) is output to the superimpose unit 25.

When the zoom switch 37 is pressed down, the CPU 15 sends a zoom control signal to the CCU 3 through the RS-232C I/F 11. The CCU 3 receives the zoom control signal and outputs video signals having undergone predetermined zoom processing to the picture file device 1.

When the store switch 38 is pressed down, the CPU 15 determines the signal is either a still picture store signal or a moving picture store signal. If it is the still picture store signal, the A/D converted video signals are JPEG-compressed and are recorded in the PC card 19 through the PC card I/F 12. Here, voice signals input from the voice signal input device 6 are input to the voice coding/decoding unit 29 through the A/D converting unit 28. Then, coded voice signals are also recorded in the PC card 19 by the CPU 15.

If it is the moving picture store signal, the A/D converted video signals are moving-picture compressed and are recorded in the PC card 19 by the CPU 15 through the PC card I/F 12. When voice signals from the voice signal input device 6 is input here, the input voice signal is recorded in the PC card 19 in the same manner for the still picture.

Further, the communication with the PC 13, which is connected thereto through the USB I/F 14, is performed in accordance with the above communication rules. Thus, the PC 13 can execute the operation of the remote controller 10 instead. The PC 13 is connected to the endoscope picture file device 1 through a removable connector, not shown.

The endoscope picture file device 1 and the PC 13 are connected through serial communication (USB). Then, the serial communication therebetween is performed in accordance with the above-described communication rules. Each unit can be controlled through the serial communication with the PC 13. Alternatively, functions of each unit can be diagnosed. By using the serial communication line, the control command and data of the endoscope unit 9 can be also controlled from the PC 13.

When picture data is exchanged through the serial communication line, a fast communication unit such as USB and IEEE 1394 can be used such that data transmission can be performed between the endoscope picture file device 1 and the PC 13 efficiently.

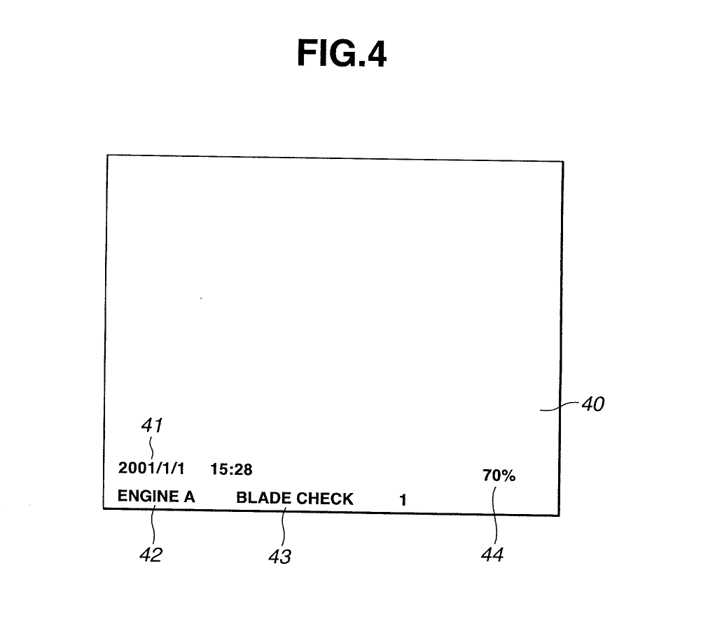

A case where a title is added to a picture will be described with reference to FIGS. 4 to 7.

A live picture 40 resulting from video signals, which are input from the CCU 3 and then are A/D converted, is displayed fully on a live screen shown in FIG. 4.

Further, graphic data, which is superimposed by the superimpose unit 25, is displayed.

A date display 41 indicates a date when the picture file device 1 is set. A directory title display 42 indicates a title of a directory in which a picture is recorded. A picture title display 43 indicates a title added to a picture to be recorded.

A PC card usage indication 44 indicates, as a percentage, a usage of the PC card 19, which is inserted into the PC card I/F 12. FIG. 4 shows that 70% of the whole capacity of the PC card 19 is used.

An operation will be described how a menu is displayed and a title is added to a given picture.

In the live picture display state shown in FIG. 4, when the lever switch 32 of the remote controller 10 is pressed down, the CPU 15 notifies a menu creation signal to the graphic processing unit 24. Thus, a live picture having a menu is displayed as shown in FIG. 5.

The menu is manipulated through a control signal based on the inclination of the lever switch 32 of the remote controller 10. Here, the IMAGE TITLE function, which is shaded in FIG. 5, is selected and is confirmed by pressing the lever switch 32. Then, a picture title input window 35 shown in FIG. 6 is displayed.

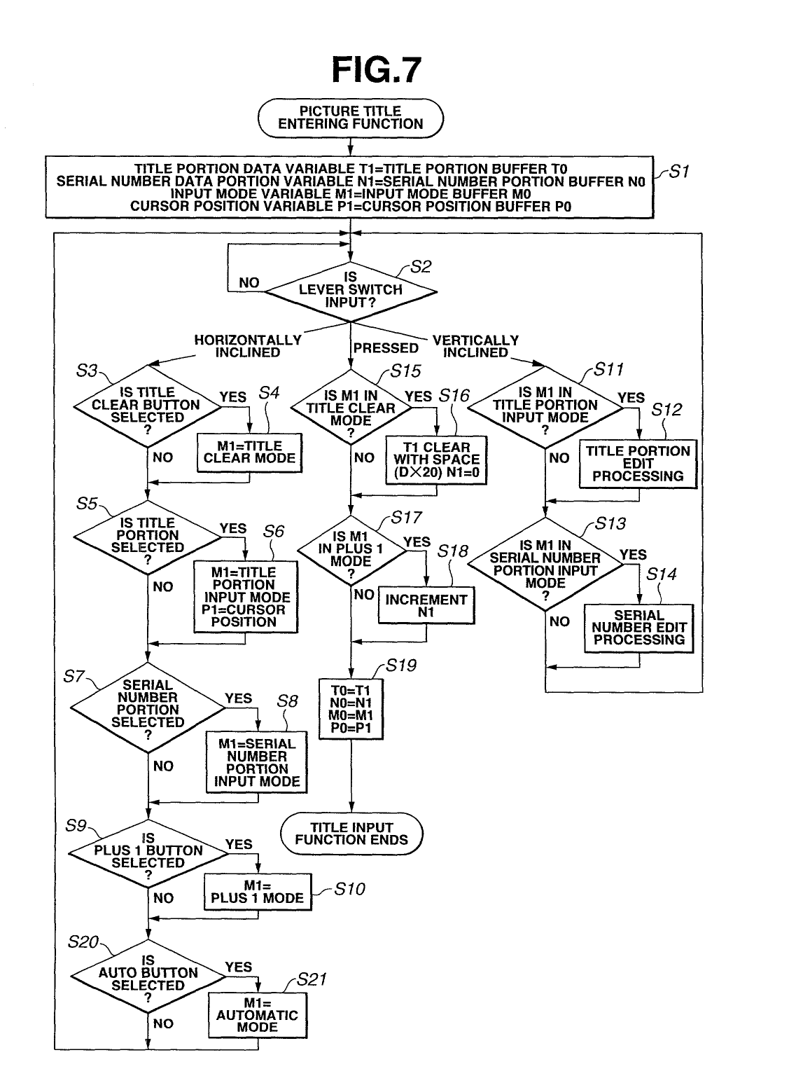

On the picture title input window 35, there are provided a title clear button 45 for totally eliminating an entered title, a title portion 46 to which a desired character string can be entered, a plus-1 button 47 for incrementing a serial number for the title entered in the title portion 46, an automatic button 88 for incrementing the serial number portion 48 and performing picture recording processing when the store switch 38 is pressed, and a serial number portion 48 for displaying a serial number. The initial value of the serial number 48 is zero The picture title input function will be described with reference to a flowchart in FIG. 7.

When the title entering function is started, in step S1, a title portion data variable T1, a serial number portion data variable N1, an input mode variable M1, a cursor position variable P1 are initialized with the title portion buffer T0, the serial number portion buffer N0, the input mode buffer M0 and the cursor position buffer P0, respectively.

The title portion data variable T1 is a variable for storing a string to be displayed in the title portion 46 on the picture title entering window 35.

The serial number portion data variable N1 is a variable for storing a number to be displayed in the serial number portion 48 on the picture title input window 35.

The input mode variable M1 is a variable for determining and storing an input mode depending on where an input target cursor 51 is positioned among the title clear button 45, the title portion 46, the serial number portion 48, the plus-1 button 47 and the automatic button 88.

The cursor position variable P1 is a variable for storing which character in the title portion 46 the input target cursor 51 is positioned on in the title portion entering mode.

A title portion buffer T0, a serial number portion buffer N0, an input mode buffer M0 and a cursor position buffer P0 backs up values of the respective variables T1, N1, M1 and P1 at the end of the picture title entering function. Then, when the picture title entering function is started next, the buffers return a state at the end of the previous picture title entering function.

In addition, the data in the title portion buffer T0 and the serial number buffer N0 is written in a file when picture or voice store processing is performed.

As shown in the steps S2 to S10, S20 and S21, by inclining the lever switch 32 of the remote controller 10 horizontally, the input target cursor 51 moves a title clear button 45, characters in the title portion 46, serial number portion 48, the plus-1 button 47, and the automatic button 88 (see steps S3, S5, S7, S9 and S20).

When the input target cursor 51 is located on the title clear button 45, the title portion 46, the serial number portion 48, the plus-1 button 47 and the automatic button 88, the input mode variable M1 is set into the title clear mode, the title portion input mode, the serial number portion mode, the plus-1 mode, and the automatic mode, respectively (see steps S4, S6, S8, S10 and S21).

When the title input mode is set in step S6, the processing returns to the step S2. Here, if the lever switch 32 is inclined upward or downward, the title edit processing in step S12 is performed after the designation in step S11.

In the title edit processing in step S12, an input character is selected by inclining the lever switch 32 upward or downward.

For example, as shown in FIG. 6, when ‘C’ is displayed and the lever switch 32 is inclined upward, ‘B’ is displayed. When the lever switch 32 is inclined downward, ‘D’ is displayed. When the lever switch 32 is continuously inclined downward to display ‘A’, and when the lever switch 32 is further inclined upward, ‘9’ is displayed. Then, when the lever switch 32 is further inclined upward, a number such as ‘8’ and ‘7’ can be entered.

When the serial number input mode is set in step S8, the processing returns to the step S2. Here, when the lever switch 32 is inclined upward or downward, the serial number edit processing is performed in step S14 after the designation in step S13.

In the serial number edit processing in step S14, the serial number increments by inclining the lever switch 32 upward. When the lever switch 32 is inclined downward, the serial number decrements. For example, when the serial number is 10, it increments to 11 when the lever switch 32 is inclined upward. When the lever switch 32 is inclined downward, it decrements to 9.

When the title clear mode is set in step S4, the processing returns to the step S2. Here, when the lever switch 32 is pressed down, the title portion 46 is cleared with a space in step S16 after the designation in step S15. The serial number portion 48 is returned to zero (0).

When the plus-1 mode is set in step S10, the processing returns to step S2. Here, when the lever switch 32 is pressed down, the serial number portion 48 increments in step S18 after the designation in step S17.

In the same manner, when the automatic mode is set in step S20, the processing returns to step S2.

At the end of the picture title input function, as shown in step S19, the title portion buffer T0, the serial number portion buffer N0, the input mode buffer M0 and the cursor position buffer P0 set (back up) the values of the variables T1, N1, M1 and P1. Then, when the processing is started next time, these buffers recover the state at the end of the previous title input function.

Like the case for the examination of the turbine blades in the above-described jet engine, when the title input function is applied to the examination works such as subject identification in the live picture 40, the picture freeze, titling function and picture store, it is convenient as described in the following:

Before the examination starts, a string such as “BLADE CHECK” is entered in the title portion 46 in advance. Then, the input target cursor 51 is positioned on the plus-1 button 47, and the lever switch 32 is pressed down. Here, the serial number portion 48 becomes 1. Then, the first picture, which includes “BLADE CHECK” in the title portion 46 and “1” in the serial number portion, is stored.

Subsequently, the adjacent turbine blade is identified on the screen of the video output device 4. The lever switch 32 is pressed only twice for the title input after the freeze.

In other words, when the lever switch 32 is pressed again, the picture title input function is ended. Here, through the initialization by substituting the input mode buffer M0 for the input mode variable M1, the previous plus-1 mode is recovered. Thus, the input target cursor 51 is positioned on the plus-1 button 47. Therefore, when the lever switch 32 is pressed again, the serial number portion 48 is incremented and the picture title input processing ends.

When the picture is stored, a picture including “BLADE CHECK” in the title portion 46 and “2” in the serial number portion 48 is also stored.

Furthermore, before the examination starts, a string such as “BLADE CHECK” is entered in the title portion 46 in advance, and the input target cursor 51 is positioned on the automatic button 88. Then, the lever switch 32 is pressed down.

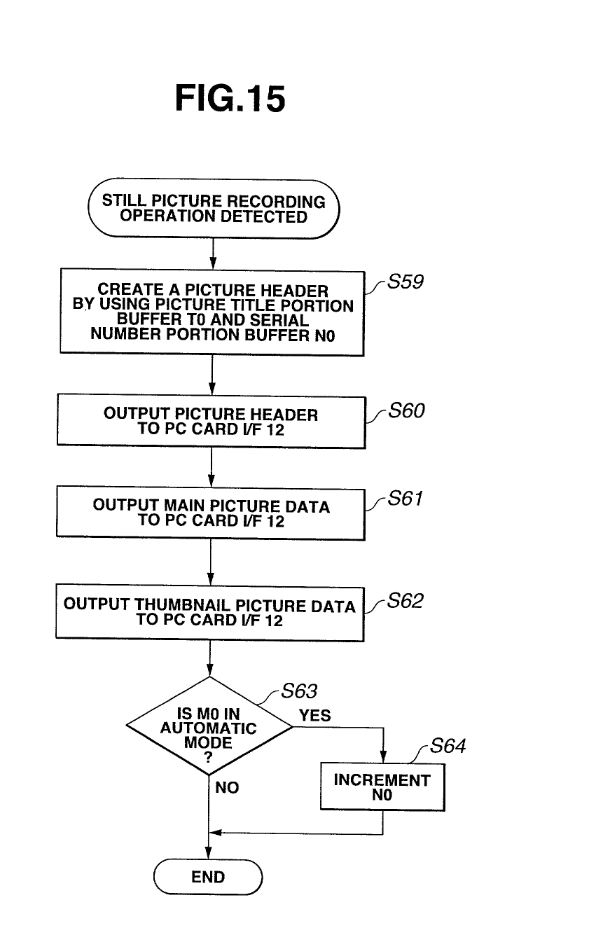

Here, when a first picture is stored, recording processing is performed in accordance with a flow shown in FIG. 15. Then, the serial number portion becomes 1, and a picture including “BLADE CHECK” in the title portion 46 and “1” in the serial number portion 48 is stored.

The recording processing in accordance with a processing flow in FIG. 15 will be described later.

Subsequently, an adjacent turbine blade is identified on the screen of the video output device 4. The serial number portion 48 is incremented after the freeze by pressing the store switch 38. In other words, once the picture is stored, the serial number portion 48 is incremented and the picture is recorded in accordance with the processing flow in FIG. 15.

Next, operations for displaying a menu and for adding a title to a given directory will be described. In the state displaying a live screen shown in FIG. 4, when the lever switch 32 of the remote controller 10 is pressed down, the CPU 15 notifies a menu creation signal to the graphic processing unit 24. Thus, a live screen having a menu as shown in FIG. 5 is displayed.

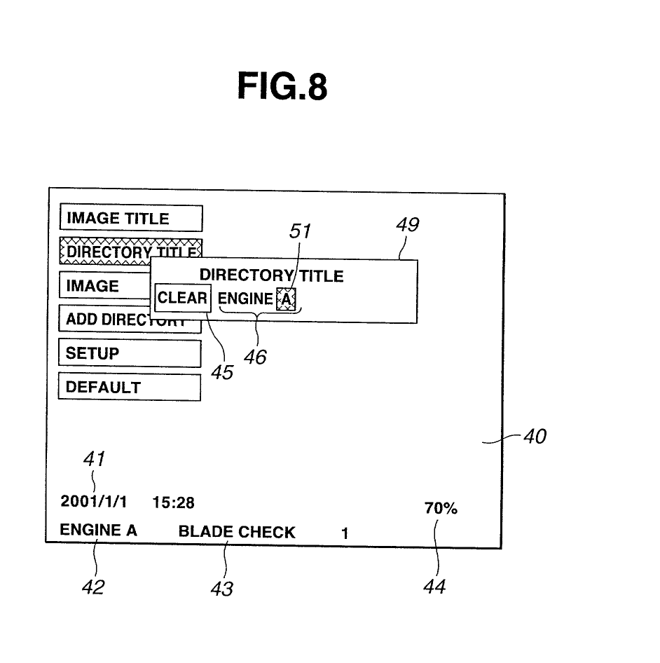

The menu is manipulated through a control signal based on the inclination of the lever switch 32 of the remote controller 10. The DIRECTORY TITLE function, which is shaded in FIG. 8, is selected and designated by pressing the lever switch 32 down. Then, a directory title input window 49 shown in FIG. 8 is displayed. The directory title input window 49 includes the title clear button 45 for totally eliminating an entered title and a title portion 46 in which a desired string can be entered.

After the selection of the DIRECTORY TITLE function shown in the directory title input window 49 in FIG. 8, a title can be added to the directory by performing operations on the title portion 46 and the title clear button 45 in the same manner as that for the picture title input function described in FIG. 6.

FIG. 9 is a block diagram showing the configuration of the system control unit 2 in FIG. 1.

As shown in FIG. 9, the system control unit 2 functionally includes a still picture data recording control unit 54, that is picture recording control means, a moving picture data recording control unit 55, a voice data recording control unit 56, a still picture data output control unit 57, a moving picture data output control unit 58, a voice data output control unit 59, an operation detecting unit 60, an endoscope unit control unit 61, a CCU control unit 62, a display picture output control unit 63, a clock 64, and a directory title recording control unit 65, that is information recording control means.

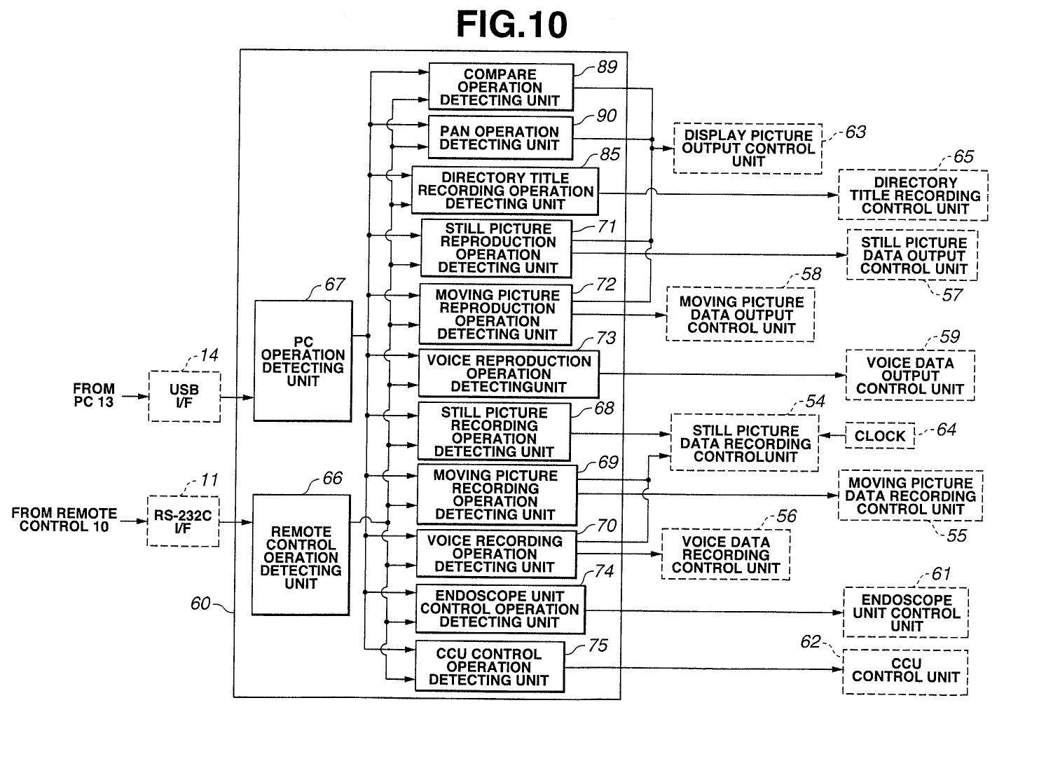

The still picture data recording control unit 54, that is the picture recording control means, writes still picture data, which is compressed by the JPEG compression/expansion unit 21 and the picture title input from the still picture operation detecting unit (see the reference numeral 68 in FIG. 10) within the operation detecting unit 60 into the PC card 19 through the PC card I/F 12.

The moving picture data recording control unit 55 writes moving picture data, which is compressed by the moving picture compression/expansion unit 23, into the PC card 19 through the PC card I/F 12.

The voice data recording control unit 56 writes voice data, which is voice-encoded by the voice signal processing circuit 8, into the PC card 19 through the PC card I/F 12.

The still picture data output control unit 57 reads out still picture data from the PC card I/F 12 and output the data to the JPEG compression/expansion unit 21. Furthermore, the still picture data output control unit 57 outputs a picture title and a directory title to the graphic processing unit 24.

The moving picture data output control unit 58 read out moving picture data from the PC card I/F 12 and outputs the data to the moving picture compression/expansion unit 23.

The voice data output control unit 59 reads out voice data from the PC card I/F 12 and outputs the voice data to the voice signal processing circuit 8.

The operation detecting unit 60 detects a control signal from the remote controller 10 through the RS-232C I/F 11 and a control signal from the PC 13 through the USB I/F 14.

Here, when the control signal from the PC 13 indicates a picture recording operation, the picture is recorded and the serial number unit is incremented if the input mode variable M0 is in the automatic mode, as described in FIG. 15.

The endoscope unit control unit 61 obtains an output from the operation detecting unit 60 and outputs an endoscope unit control signal such as an angle control signal to the endoscope unit 9 through the RS-232C I/F 11.

The CCU control unit 62 obtains an output from the operation detecting unit 60 and outputs a CCU control signal such as a zoom control signal to the CCU 3 through the RS-232C I/F 11.

The display picture output control unit 63 obtains an output from the operation detecting unit 60 and outputs a video signal from the JPEG compression/expansion unit 21 and video data from the moving picture compression/expansion unit 23 through the superimpose unit 25 when an operation for reproducing still picture data or moving picture data is detected. When an operation on the still picture data or moving picture data except for the reproduction is detected, the superimpose unit 25 is controlled such that video picture data can be output from the A/D converting unit 20 through the superimpose unit 25.

When an output is obtained from the operation detecting unit 60 and a compare display operation is detected, the superimpose unit 25 is controlled such that video data from the A/D converting unit 20 and video data from the JPEG compression/expansion unit 21 or the moving picture compression/expansion unit 23 can be output from the superimpose unit 25 by switching them on a single screen.

When an output is obtained from the operation detecting unit 60 and a pan operation for a reproduced picture is detected, the JPEG compression/expansion unit 21 is controlled so as to change a position for reading from the VRAM 22.

The clock 64 gives date information to the still picture data recording control unit 54 for recording, for example, date when still picture data is recorded.

The directory title recording control unit 65, that is an information recording control unit, creates a directory title recording file from a directory title entered by using the directory title input function and records it into PC card 19 through the PC card I/F 12.

FIG. 10 is a block diagram showing the configuration of the operation detecting unit 60 in FIG. 9.

As shown in FIG. 10, the operation detecting unit 60 includes a remote controller operation detecting unit 66, a PC operation detecting unit 67, a still picture recording operation detecting unit 68, a moving picture recording operation detecting unit 69, a voice recording operation detecting unit 70, a still picture reproduction operation detecting unit 71, a moving picture reproduction operation detecting unit 72, a voice reproduction operation detecting unit 73, an endoscope unit control operation detecting unit 74, a CCU control operation detecting unit 75, a directory title recording control detecting unit 85, a compare operation detecting unit 89, and a pan operation detecting unit 90.

The remote control operation detecting unit 66 detects an operation instruction and text data such as picture titles and directory titles input from the remote controller 10.

The PC operation detecting unit 67 detects an operation instruction and the text data input from the PC 13.

The still picture recording operation detecting unit 68 detects an operation instruction for recording still pictures and an operation instruction for inputting picture titles and directory titles.

The moving picture recording operation detecting unit 69 detects an operation instructions for recording an moving picture and outputs a recording instruction to the moving picture data recording control unit 55. Then the moving picture recording operation detecting unit 69 outputs a recording instruction to the still picture data recording control unit 54.

The voice recording operation detecting unit 70 detects an operation instruction for recording voice and outputs a recording instruction to the voice data recording control unit 56 and outputs a recording instruction to the still picture data recording control unit 54.

The still picture reproduction operation detecting unit 71 detects an operation instruction for reproducing a still picture.

The moving picture reproduction operation detecting unit 72 detects an operation instruction for reproducing a moving picture.

The voice reproduction operation detecting unit 73 detects an operation instruction for reproducing voice.

The endoscope unit control operation detecting unit 74 detects an endoscope unit control operation.

The CCU control operation detecting unit 75 detects a CCU control operation.

The directory title recording operation detecting unit 85 detects an input instruction for the directory title input function.

The compare operation detecting unit 89 detects a compare display operation instruction.

The pan operation detecting unit 90 detects a pan operation instruction for a reproduced picture.

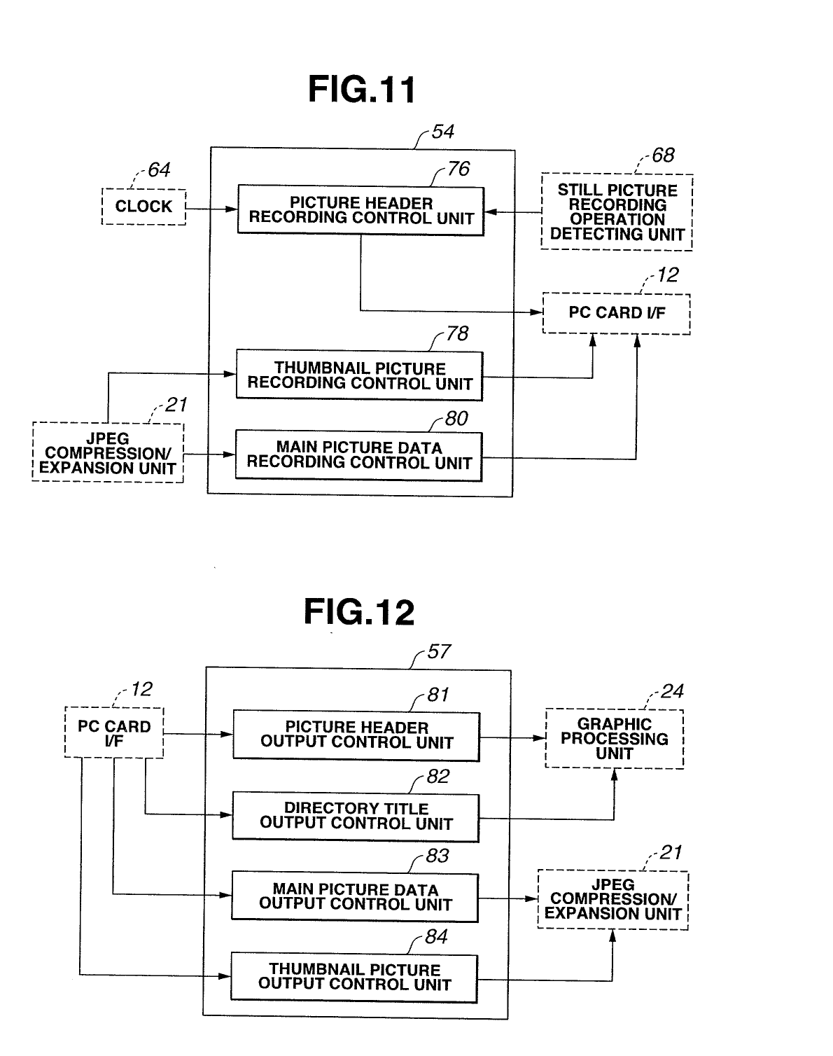

FIG. 11 is a block diagram showing the configuration of the still picture data recording control unit 54, that is a picture recording control unit in FIG. 9.

As shown in FIG. 11, the still picture data recording control unit 54 includes a picture header recording control unit 76, a main picture data recording control unit 80 and a thumbnail picture recording control unit 78.

The picture header recording control unit 76 creates a picture header portion from a picture title input from, for example, the still picture recording operation detecting unit 68 and a date when still picture data is recorded, which is input from the clock 64, and outputs the picture header portion to the PC card I/F 12.

The main picture data recording control unit 80 outputs compressed picture data as main picture, which is input from the JPEG compression/expansion unit 21, to the PC card I/F 12.

The thumbnail picture recording control unit 78 skip-reads out compressed picture data input from the JPEG compression/expansion unit 21 in order to create thumbnail picture data. Then, the thumbnail picture data is output to the PC card I/F 12.

FIG. 12 is a block diagram showing the configuration of the still picture data output control unit 57 in FIG. 9.

As shown in FIG. 12, the still picture data output control unit 57 includes a picture header output control unit 81, a directory title output control unit 82, a main picture data output control unit 83, and a thumbnail picture output control unit 84.

The picture header output control unit 81 reads out still picture data from the PC card I/F 12 and outputs a date and picture title data from the picture header portion to the graphic processing unit 24.

The directory title output control unit 82 reads out a directory title recording file from the PC card I/F 12 and outputs a directory title to the graphic processing unit 24.

The main picture data output control unit 83 outputs main picture data from the PC card I/F 12 to the JPEG compression/expansion unit 21.

The thumbnail picture output control unit 84 outputs thumbnail picture data from the PC card I/F 12 to the JPEG compression/expansion unit 21.

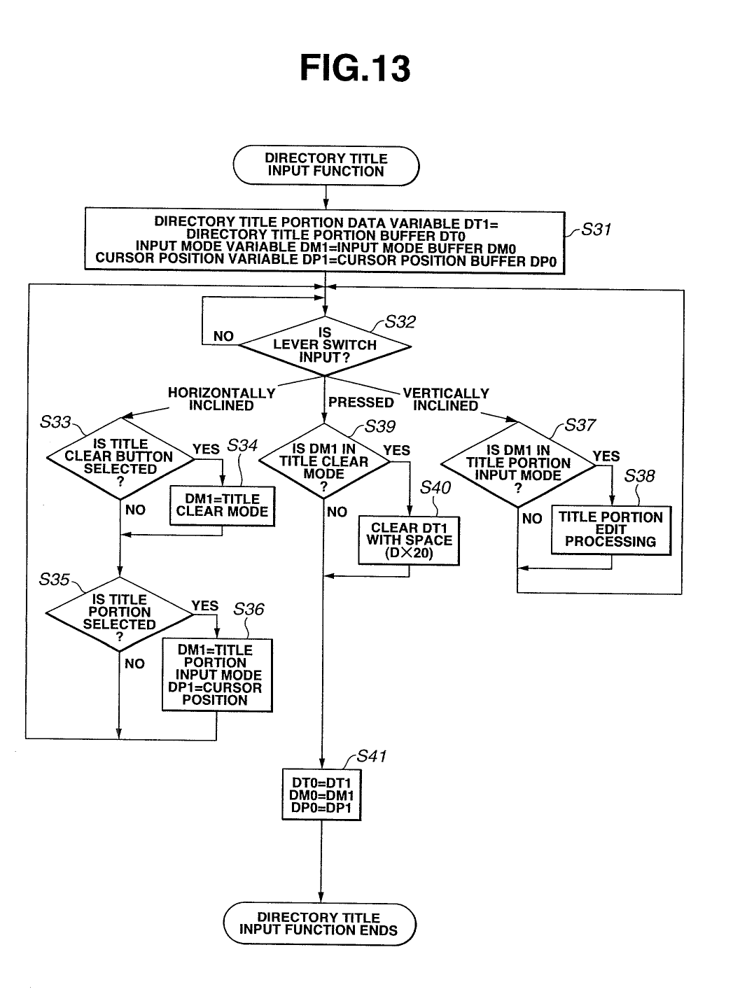

Next, the directory title input function will be described with reference to the flowchart in FIG. 13.

When the directory title input function is started, the processing goes to a step S31. In the step S31, a directory title portion data variable DT1, an input mode variable DM1 and a cursor position variable DP1 are initialized with a directory title portion buffer DT0, an input mode buffer DM0 and a cursor position buffer DP0, respectively.

The directory title portion data variable DT1 is a variable for storing a string to be displayed in the title portion 46 on the directory title entering window 49.

The input mode variable M1 is a variable for determining and storing an input mode depending on where an input target cursor 51 is positioned among the title clear button 45 and the title portion 46.

The cursor position variable DP1 is a variable for storing which character the input target cursor 51 is positioned on in the title portion 46 when the title portion entering mode.

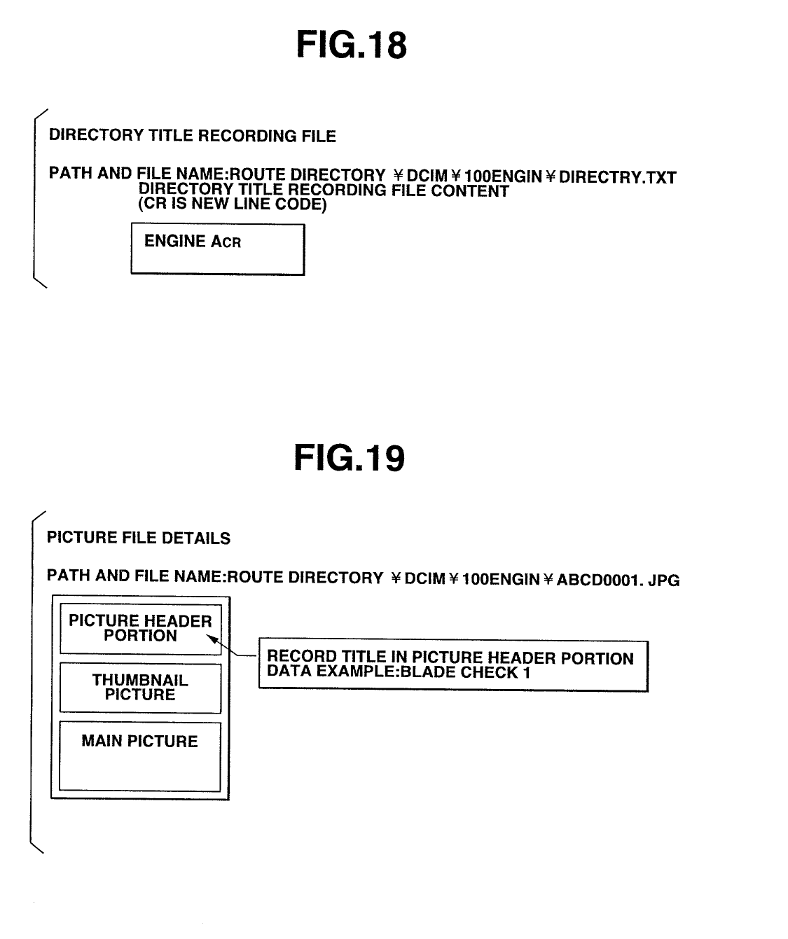

The directory title portion buffer DT0, the input mode buffer M0 and the cursor position buffer DP0 back up values of the respective variables DT1, DM1 and DP1 at the end of the directory title entering function. Then, when the directory title entering function is started next, the buffers return a state at the end of the previous directory title entering function. In addition, the content in the directory title portion buffer DT0 is written in the directory title recording file shown in FIG. 18. After the step S31, the processing goes to the step S32, where an input by the lever switch 32 of the remote controller 10 is determined.

Referring to FIG. 8, by inclining the lever switch 32 of the remote controller 10 leftward or rightward, the input target cursor 52 moves the title clear button 45 and each character in the title portion 46.

In steps S33 and S35, it is determined that whether the input target cursor 51 selects the title clear button 45 or the title portion 46.

In the step S33, when the input target cursor 51 is positioned on the title clear button 45, the processing goes to a step S34, where the input mode variable DM1 is set into the title clear mode.

In the step S35, when the input target cursor 51 is positioned on the title portion 46, the processing goes to a step S36, the input mode variable DM1 is set into the title portion input mode. After that, the processing returns to the step S32.

When the title portion input mode is set and when the lever switch 32 is inclined upward or downward in the step S32, the title edit processing is performed in a step S38 after the title portion input mode designation in a step S37.

The title edit processing selects an input character by inclining the lever switch 32 upward or downward. For example, as shown in FIG. 8, when ‘A’ is displayed and the lever switch 32 is inclined upward, ‘9’ is displayed. When the lever switch 32 is inclined downward, ‘B’ is displayed. When the lever switch 32 is further inclined downward, ‘C’ and ‘D’ are displayed sequentially. Then, when the lever switch 32 is further inclined upward in the state displaying ‘9’, a number such as ‘8’ and ‘7’ can be entered.

When the title clear mode is set and when the lever switch 32 is pressed down in the step S32, the title portion 46 is cleared with a space in step S40 after the title clear mode designation in step S39.

At the end of the directory title input function, the directory title portion buffer DT0, the input mode buffer DM0 and the cursor position buffer DP0 set (back up) the values of the variables DT1, DM1 and DP1 in a step S41. Then, when the processing is started next time, these buffers recover the state at the end of the previous directory title input function.

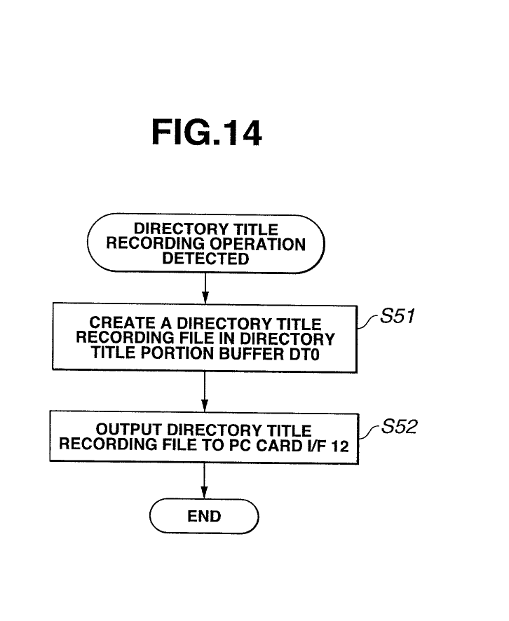

The directory title recording file, which is input in the above manner, is recorded in the PC card 19 as shown in a flowchart in FIG. 14.

In FIG. 14, when a directory title recording operation is detected by the directory title recording operation detecting unit 85 shown in FIG. 10, the directory title recording control unit 65 creates a directory title recording file by using the directory title portion buffer DT0 in a step S51. Then, in a step S52, the directory title recording file is output to the PC card I/F 12.

FIG. 15 shows a flow of processing for recording a still picture.

In FIG. 15, when a still picture recording operation is detected by the still picture recording operation detecting unit 68 shown in FIG. 10, the still picture data recording control unit 54 creates a picture header by using the picture title portion buffer T0 and the serial number portion buffer N0 in a first step S59. In a step S60, the picture header is output to the PC card I/F 12. Subsequently, in a step S61, main picture data is output to the PC card I/F 12. Then, in a step S62, thumbnail picture data is output to the PC card I/F 12.

Then, in a step S63, the input mode buffer M0 determines whether it is in the automatic mode. If it is not in the automatic mode, the processing in FIG. 15 ends without any operation. If it is in the automatic mode, the processing goes to a step S64, where the serial number portion buffer N0 is incremented and the processing in FIG. 15 ends.

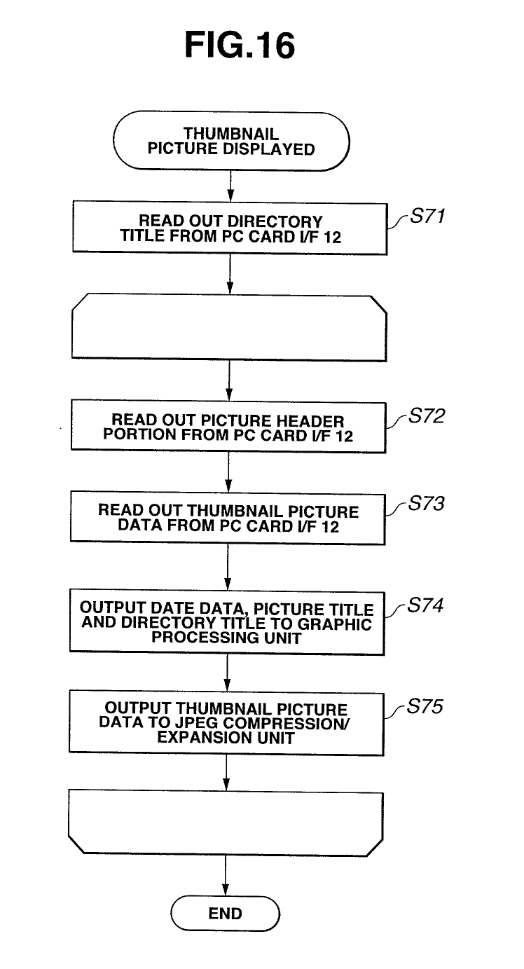

FIG. 16 shows a flow of processing for displaying a thumbnail picture.

In FIG. 16, a directory tile is read first from a directory title recording file, which is recorded in the PC card 19, through the PC card I/F 12 in a step S71 and then is output to the graphic processing unit 24 (refer to FIG. 2).

Subsequently, following processing is repeated for each still picture.

In a step S72, a picture header portion is read out from the PC card I/F 12. In a step S73, a thumbnail picture data is read out from the PC card I/F 12. Next, in a step S74, date data, a picture title and a directory title are output to the graphic processing unit 24. In a step S 75, the thumbnail picture data is output to the JPEG compression/expansion unit 21.

The picture file, which is recorded in the above manner, is recorded in the PC card 19 through the PC card I/F 12.

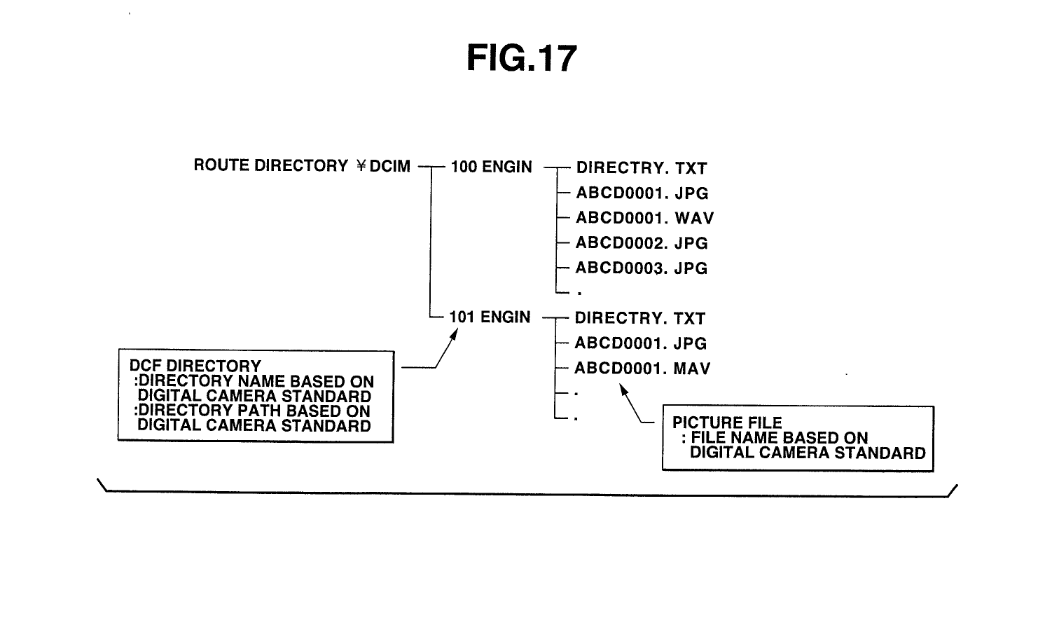

It is recorded in the PC card 19 as shown in FIG. 17.

DCIM directory is created in a route directory in the PC card 19 in accordance with the DCF standard. Thus, a DCF directory is created like “100ENGIN” and “101ENGIN” in a sub-directory of the DCIM directory.

A directory title recording file DIRECTORY.TXT is recorded in each DCF directory, as shown in FIG. 18, where a directory title, which is given by the directory title function as described with reference to FIGS. 8 and 13, is recorded.

Furthermore, still picture data (ABCD0001.JPG, for example), voice data (ABCD0001.WAV, for example) and moving picture data (ABCD0001.MOV, for example) are recorded in the DCF directory.

As shown in FIG. 19, a picture title is recorded in the picture header portion of the picture file.

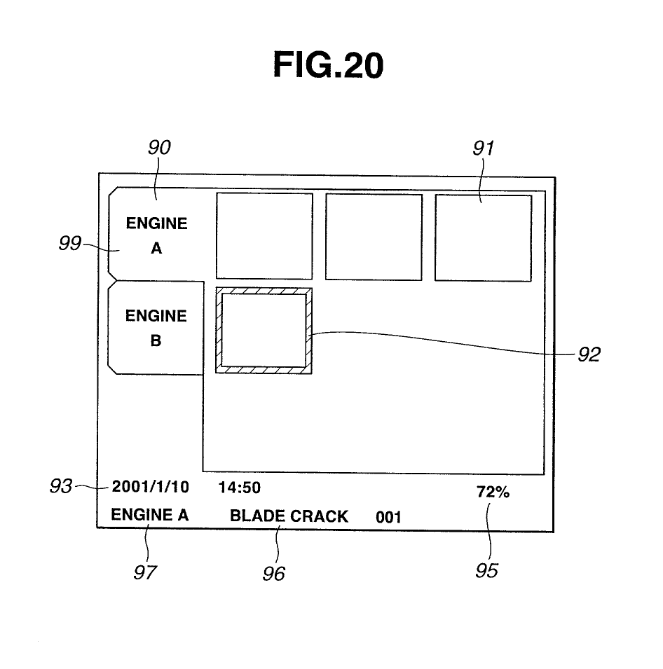

FIG. 20 shows thumbnail pictures, which have been recorded in the above manner, for viewing pictures within the PC card 19.

In FIG. 20, the directory is divided by a directory tabs 99, and a directory title 90 is displayed on each of the tubs. A thumbnail picture 91, which is recorded in the directory is displayed on each directory tub 99.

A picture recorded data 93 for the thumbnail picture 91, which is selected by the thumbnail select cursor 92, is displayed at the bottom of the screen. A media usage 95, a directory title 90, a picture title 96 and a directory title display 97 are displayed in the same manner like the live screen.

A still picture of a desired thumbnail picture 91 can be reproduced on the thumbnail screen shown in FIG. 20.

In other words, the thumbnail select cursor 92 is positioned on a desired thumbnail picture 91 on the thumbnail screen in FIG. 20, the desired thumbnail picture 91 can be selected. Then, when a still picture reproduction operation (the lever switch 32 of the remote controller 10 is pressed) is detected by the still picture reproduction operation detecting unit 71, a main picture is reproduced and is displayed.

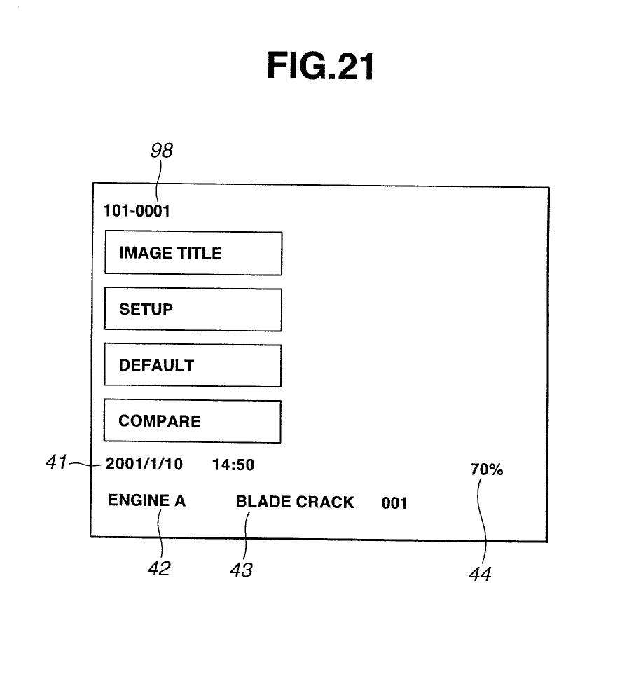

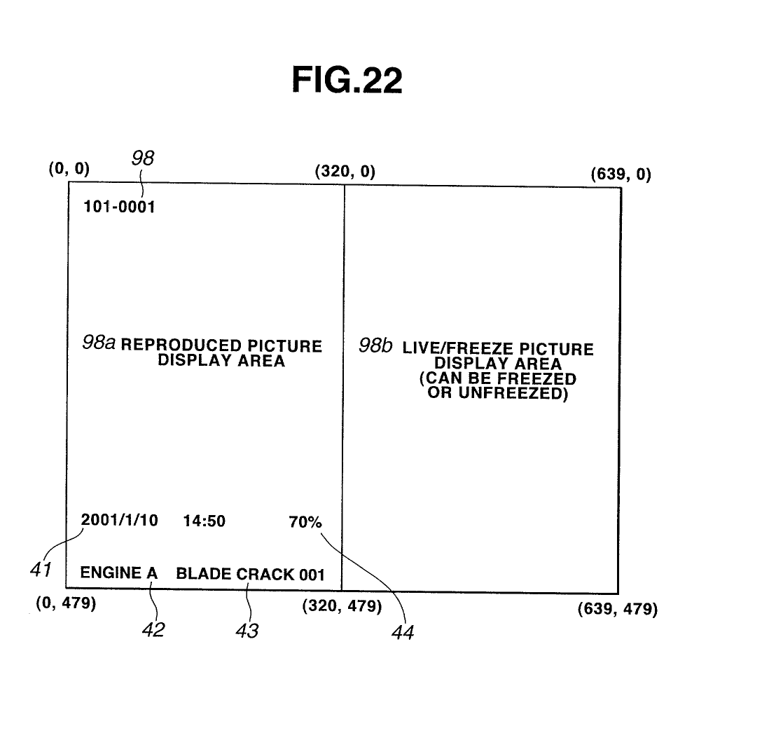

Next, a compare screen display operation will be described with reference to FIGS. 21 and 22.

When a menu display is selected on the reproduction screen, a reproduction screen having a menu, as shown in FIG. 21, is displayed. On the reproduction screen having the menu, a menu including the above-described PICTURE TITLE, SETUP, DEFAULT as well as COMPARE is displayed.

Further, on this screen, a reproduction picture directory (or folder) number (specifically 101) and a file number (specifically 0001) is displayed (98). At the bottom of the screen, reproduction picture recorded data 41, a directory title 42, a reproduction picture title 43 and a PC card usage 44 are displayed.

On this screen, the lever switch 32 of the remote controller 10 is inclined upward or downward in order to select the COMPARE menu. Then, by pressing down the lever switch 32 of the remote controller 10, the COMPARE menu is confirmed.

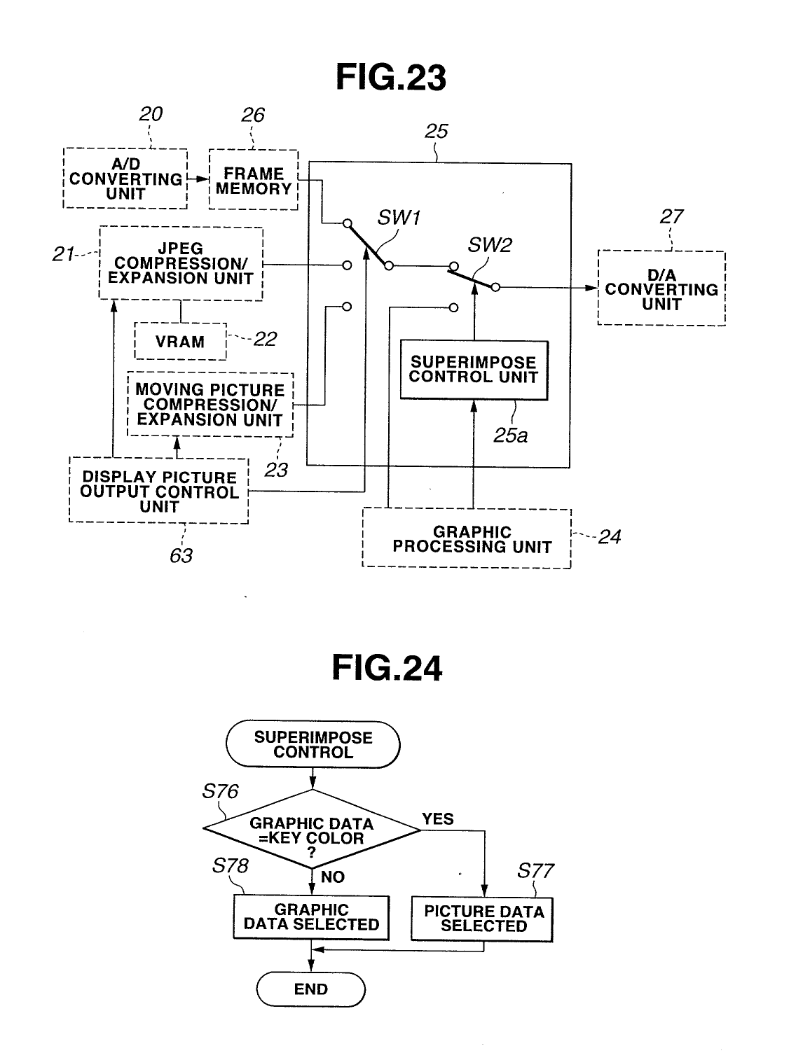

Then, when a compare display operation is detected by the compare operation detecting unit 89 shown in FIG. 10, a compare screen shown in FIG. 22 is displayed. Notably, the compare screen is displayed by controlling the superimpose unit 25 as described later with reference to FIG. 23.

The upper left corner and the lower right corner of the compare screen in FIG. 22 are an origin (0,0) and (639,479) of the two dimensional Cartesian coordinates (X, Y), respectively. An area is indicated by using two coordinate positions in a diagonal line. For example, an area of the compare screen is defined by (0,0)-(639,479). In this case, it corresponds to an area defined by four coordinate positions (0,0), (639,0), (639,479), and (0,479). An area described below is also defined in this manner.

In the compare screen, the left half, that is an area defined by (0,0)-(319,479) is a reproduced screen display area 98a where a reproduced picture is displayed. The right half, that is an area defined by (320,0)-(639,479) is a live/freeze picture display area 98b where a live picture or a freeze picture is displayed.

In the reproduced picture display area 98a, a reproduced picture directory number and a file number are displayed (98) and a reproduced picture recorded date 41, a directory title 42, a reproduced picture title 43 and a PC card usage 44 are displayed.

When the joystick 31 of the remote controller 10 is inclined to an arbitrary direction on the displayed compare screen, the angle of the end of the endoscope inserting portion 18 is controlled as described above. Thus, the end of the endoscope can be directed in the desired direction. As a result, a desired area of a subject can be observed easily.

Therefore, by setting a condition where the same area of the subject as the reproduced picture displayed on the reproduced picture display area 98a can be observed, the current state can be compared with the past state. Alternatively, by comparing the area before and after the repair, for example, whether or not the repair is surely performed can be checked.

When the freeze switch 36 of the remote controller 10 is pressed down, a live picture displayed on the live/freeze picture display area 96b can be freeze. Alternatively, the freeze picture can be returned to the live picture (by clearing the freeze function). In other words, a live picture can be frozen so that the freeze picture can be displayed. Alternatively, the freeze picture can be returned to the live picture by clearing the freeze function, and the live picture can be displayed.

By inclining the lever switch 32 of the remote controller 10 leftward or rightward, a pan operation can be performed on a reproduced picture.

FIG. 23 shows the configuration of the superimpose unit 25.

The superimpose unit 25 includes a first switch SW1, a second switch SW2 and a superimpose control unit 25a for controlling switching of the second switch SW2.

Video data, which is digital-converted in the A/D converting unit 20 and passes through the frame memory 26, a still picture, which is expanded by the JPEG compression/expansion unit 21 and is temporally stored in the VRAM22, and video data of a moving picture, which is expanded by the moving picture compression/expansion unit 23, are respectively input to the first switch SW1 through three connecting points. Then, video data selected among them through a control signal from the display picture output control unit 63 is output to the second switch SW2 through a common connecting point.

When a compare display operation is detected, the display picture output control unit 63 controls such that video data from the JPEG compression/expansion unit 21 and the moving picture compression/expansion unit 23 can be selected for the left half (0,0)-(319,479) of the screen. Furthermore, the display picture output control unit 63 controls such that video data of the live/freeze picture, which is digital-converted, from the frame memory 26 can be selected for the right half (320,0)-(639,479) of the screen.

Then, these video data are output to the D/A converting unit 27 through the second switch SW2.

Video data of two pictures on the compare screen is input to the D/A converting unit 27, where the video data is D/A converted. Then, the compare screen is displayed in the video output device 4.

When a pan operation on the compare screen is also detected by the pan operation detecting unit 90, the display picture output control unit 63 controls a horizontal reading position for video data to be read from the VRAM 22 by the JPEG compression/expansion unit 21 when the reproduced picture is a still picture. Then, the left side reproduced picture of the compare picture is panned horizontally.

When the pan operation is detected by the pan operation detecting unit 90, the display picture output control unit 63 controls a horizontal reading position for video data to be read from a memory, not shown, within the JPEG compression/expansion unit 23 if a moving picture is reproduced. Then, the left side reproduced picture of the compare picture is panned horizontally.

More specifically, the reading position is controlled such that the reproduced picture can be moved to the right on the screen when the lever switch 32 of the remote controller 10 is inclined to the right. When the lever switch 32 is inclined to the left, the reading position is controlled such that the reproduced picture can be moved to the left.

Therefore, a live picture is displayed by keeping a recorded past picture being reproduced and displayed. Thus, through an operation performed on the joystick 31 of the remote controller 10, a live picture can be selected and set (or changed) to a desired position by comparing both pictures. Thus, through the above-described pan operation, the reproduced picture can be moved leftward or rightward.

In other words, a displayed area selecting operation can be performed simultaneously both on the reproduced picture and the live picture (also on the still picture) that are displayed in alignment horizontally.

For the still picture instead of the live picture, an address for reading the frame memory 26 which stores video data of the still picture is moved leftward or rightward so that the still picture displayed at the right side of the compare screen can be moved and adjusted.

Video data selected through the first switch SW1 and graphic data created by the graphic processing unit 24 are input to the second switch SW2. Then, the switching therebetween can be controlled from the superimpose control unit 25a.

The graphic processing unit 24 creates graphic data for one screen by using a color (called “key color”), which is not used in the screen display (such as menu display).

Furthermore, graphic data such as the menu is overwritten on the key color screen and is output to the second switch SW2.

The superimpose control unit 25a controls the switching of the second switch SW2 such that video data can be selected for the key color part and such that graphic data can be selected for colors other than the key color.

In other words, superimpose control is performed, as shown in FIG. 24.

As shown in FIG. 24, the superimpose control unit 25a determines whether or not the graphic data created by the graphic processing unit 24 is a predetermined key color (step S76).

Then, if the graphic data is the predetermined key color, video data is selected in a step S77. On the other hand, if the graphic data is not the predetermined key color, that is, a color, which is not the key color, graphic data is selected in a step S78. Then, the selected data is output from the superimpose potion 25.

In this way, according to the first embodiment of the present invention, the reproduction by using a commercially available digital camera and the printing by using the peripheral device such as a digital camera printer are allowed, and picture data can be easily managed. An endoscope picture file device can be achieved whereby, even when a number of subjects, which are alike in form, exist, titles can be easily given to picture data. In addition, a directory title related to a picture data can be given thereto.

Then, a directory title and a picture title are recorded in different files and the directory title recording file is recorded in a DCF directory. Since the directory title and the picture data are handled separately, even when picture data is transferred to the PC 13 through, for example, the USB I/F 14, only the picture file is transferred without any consideration about the directory title.

In a reproduction picture having a menu, by selecting a COMPARE menu, a compare screen can be obtained where a reproduced picture and a live picture (including a freeze picture) are aligned horizontally. In this case, the reproduced picture, which is displayed through a pan operation, can be moved to the leftward or rightward (horizontal) direction easily. Furthermore, the position displaying the live picture can be moved (in the leftward or rightward direction and in the other direction) through an angle operation (by using the joystick 31 of the remote controller 10).

When a freeze picture (still picture) is displayed instead of the live picture, the displayed picture can be panned leftward and rightward. Therefore, according to this embodiment, positions of displaying a past reproduced picture and a current live picture are changed such that both pictures can be easily compared by a user such as an operator. For example, a picture before repair processing and a picture after the repair processing can be checked easily by setting them in the same observation condition, which can significantly improves the operability.

Therefore, according to this embodiment, the current picture and the past picture of a subject can be displayed in alignment. In this case, the area displaying both pictures can be changed independently. Thus, the focused areas can be displayed such that the comparison between the areas can be performed easily.

In the first embodiment, a picture title is held within a picture file, and a directory title is held in a file different from the picture file. Thus, they are displayed instead of the real file name and the directory name. In the following second embodiment, an example will be described where a combination of a picture title and a directory title is held in a picture file and they are displayed instead of the real file name and directory name.

The displayed area of the live picture, which is displayed at the left of the compare screen shown in FIG. 22, can be changed through the joystick 31 of the remote controller 10. However, the displayed area can be changed through an operation for changing an address to be read out from the frame memory 26, that is, through a pan operation in the same manner like the freeze picture.

A select unit can be provided for selecting between a pan operation at the reproduced picture side and a pan operation at the live picture side such that both operations can be performed freely when the compare screen is displayed. Alternatively, when the pan operation is selected, a screen for selecting either a pan operation at the reproduced picture side and a pan operation at the live picture side may be displayed so as to perform the pan operation on the selected side.

Second Embodiment

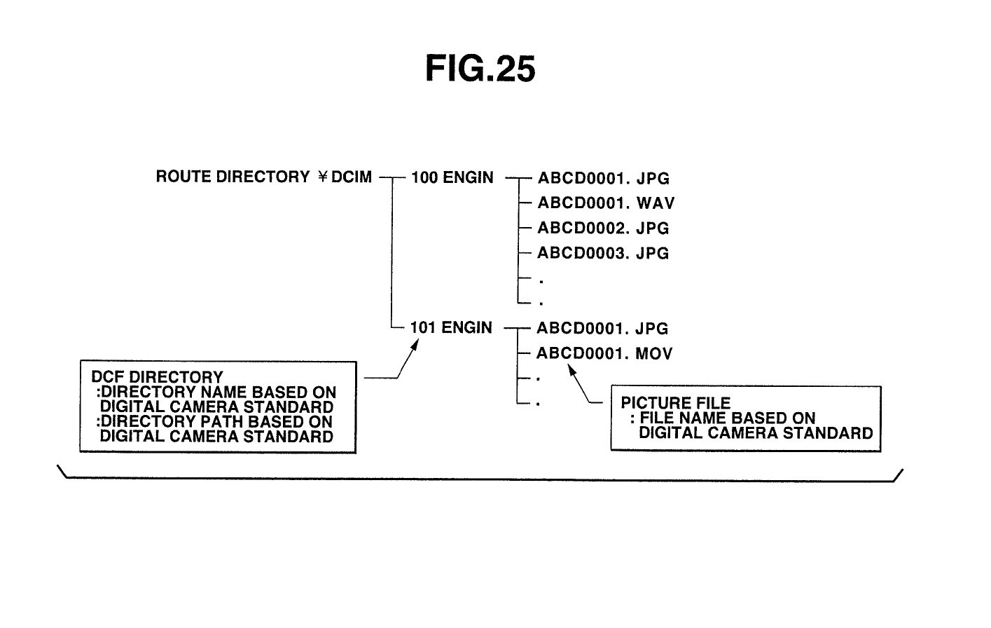

A second embodiment adopts the data configuration without any specific directory title recording file (see DIRECTORY.TXT shown in FIG. 17) as shown in FIG. 25. In this case, a directory title and a picture title are recorded in a picture header portion, as shown in FIG. 27.

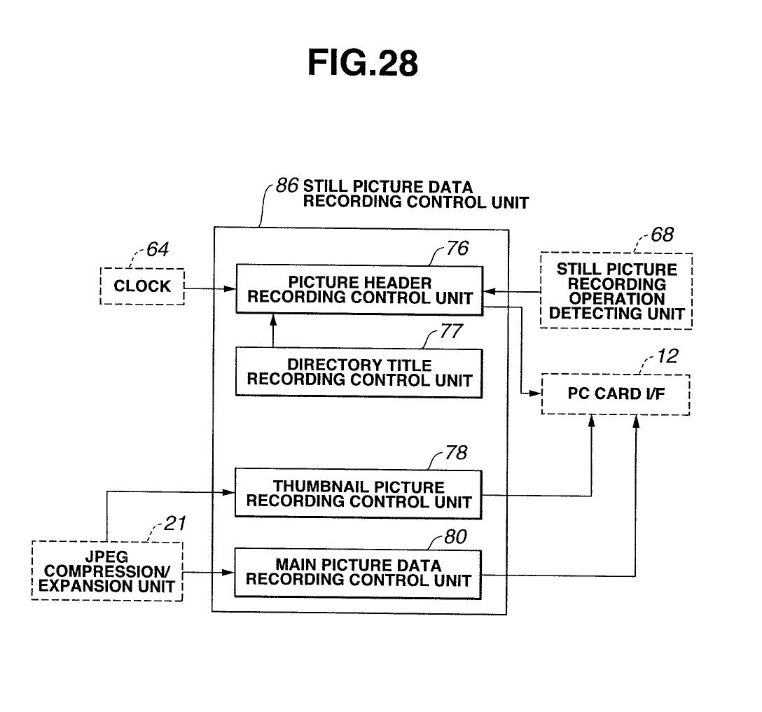

When a directory title and a picture title are recorded in a picture header portion, a directory title recording file is not needed. Thus, there is an advantage that the directory title and the picture title can be recorded even in the PC card 19 having a small capacity. The directory title recording control unit 65 shown in FIGS. 9 and 10 is no longer needed. Then, the still picture data recording control unit 54 shown in FIG. 11 is replaced by a still picture data recording control unit 86 shown in FIG. 28.

In FIG. 28, the still picture data recording control unit 86, which is a picture and information recording control unit, includes the configuration of the still picture data recording control unit 54 shown in FIG. 11 (a picture header recording control unit 76, a thumbnail picture recording control unit 78, and main picture data recording control unit 80) in addition to a directory title recording control unit 77.

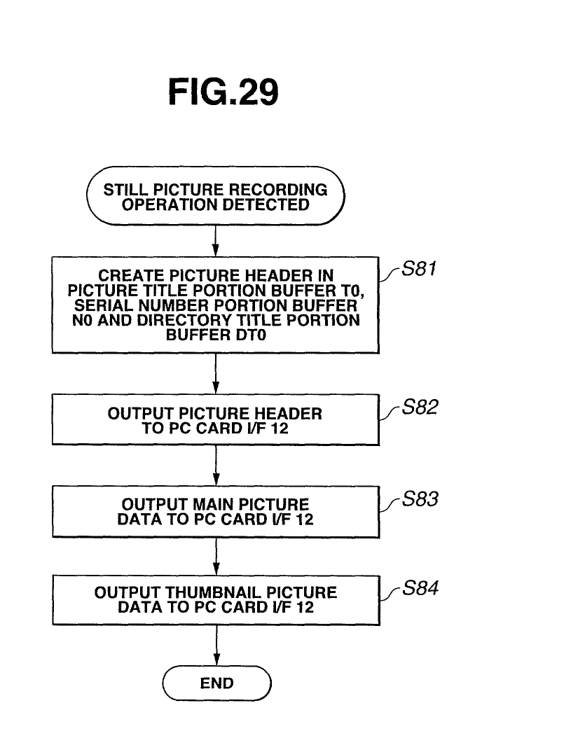

FIG. 29 shows a flow of processing for recording still picture data by using the still picture data recording control unit 86, which is constructed as shown in FIG. 28.

When a still picture recording operation is detected by the still picture recording operation detecting unit 68, the still picture data recording control unit 86 creates a picture header by using the picture title portion buffer T0, the serial number portion buffer N0, and the directory title portion buffer DT0 in a step S81. Then, in a step S82, the picture header is output to the PC card I/F 12.

Subsequently, main picture data is output to the PC card I/F 12 in a step S83. Then, in a step S84, thumbnail picture data is output to the PC card I/F 12.

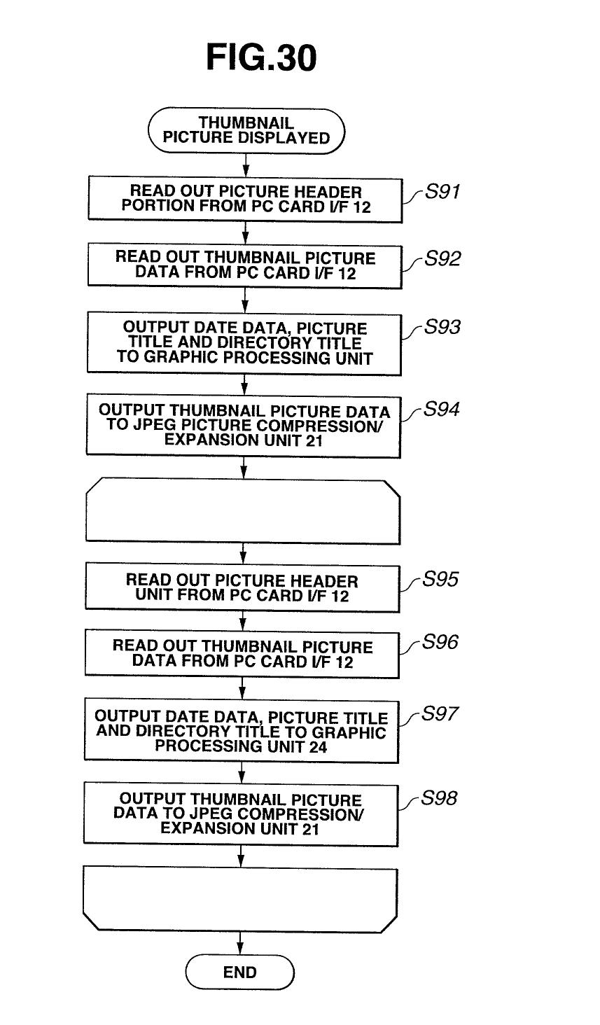

FIG. 30 shows a flow of processing for displaying a thumbnail screen.

In order to display a directory title on a directory tub, a picture is read out first. In other words, a picture header portion is read out through the PC card I/F 12 in a step S91. Then, a thumbnail picture data is read out through the PC card I/F 12 in a step S92.

Subsequently, date data, a picture title and a directory title are read from the picture header portion in a step S93 and are output to the graphic processing unit 24.

Here, a directory title along with the date data and the picture title are displayed on the directory tub in the thumbnail screen.

Then, the thumbnail picture data is output to the JPEG compression/expansion unit 21 in a step S94.

Furthermore, the following processing is repeated for each of still pictures.

A picture header portion is read out through the PC card I/F 12 in a step S95. Also, thumbnail picture data is read out through the PC card I/F 12 in a steps S96.

Then, date data, a picture title, and a directory title are read from the picture header portion in a step S97 and are output to the graphic processing unit 24. The thumbnail picture data is output to the JPEG compression/expansion unit 21 in a step S98.

According to the above second embodiment, when a directory title and a picture title are recorded in the same file, a specific file for holding the directory title is not needed. Thus, a PC card having a small capacity can be used.

As described above, according to the present invention, a picture file device, which can reproduce a picture by using a commercially available digital camera, can print the picture by using peripheral devices such as a printer for the digital camera, can manage pictures easily, and can easily add titles to pictures of multiple subjects, which are similar in form, can be realized.

Even when pictures, which are alike in form, are recorded like at the examination of the turbine blades in a jet engine, only the minimum title input operations are required and special switches for giving numbers thereto are not needed.

Having described the preferred embodiments of the invention referring to the accompanying drawings, it should be understood that the present invention is not limited to those precise embodiments, but various changes and modifications thereof could be made by one skilled in the art without departing from the spirit or scope of the invention as defined in the appended claims.

What is claimed is:

1. A picture file device having recording means for recording a still picture, comprising:
control means having communication means for outputting a control signal to a function unit based on a control signal received by the communication means;
recording operation detecting means for detecting a picture recording operation; and
picture recording control means for, when the picture recording operation is detected by the recording operation detecting means, creating a picture file having a first area for storing data of the still picture and a second area for storing first text data relating to the still picture data and for outputting the created picture file to the recording means.

2. The picture file device according to claim 1, in which the first text data has a string portion including desired characters and number data, further comprising:
first operation processing means for incrementing the number data; and
second operation processing means for incrementing the number data when the picture recording operation is detected.

3. The picture file device according to claim 1, wherein a picture title is held in the picture file and a directory title is held in a file different from the picture file, both of which are displayed instead of the file name and the directory name.

4. The picture file device according to claim 1, where a combination of a picture title and a directory title is held within the picture file and is displayed instead of the file name and the directory name.

5. The picture file device according to claim 3, wherein the picture title includes a string portion to which a desired character can be entered and a serial number portion where a serial number can be entered, the device further comprising operating means for incrementing the serial number portion.

6. The picture file device according to claim 4, wherein the picture title includes a string portion to which a desired character can be entered and a serial number portion where a serial number can be entered, the device further comprising operating means for incrementing the serial number portion.

7. A picture file device, comprising:
comparison display means for displaying a first picture indicating a current state of a subject and a second picture indicating a past state of the subject, which is read from picture recording means, in alignment at the same time by switching picture switching means; and
displayed area changing means for independently changing displayed area of the first picture and the second picture, which are displayed in the display means.

8. The picture file device according to claim 7, wherein the first picture is a moving picture or a freeze still picture indicating a current state of a subject.

9. The picture file device according to claim 7, wherein the second picture is a moving picture or a still picture.

10. The picture file device according to claim 7, wherein the first picture and the second picture are displayed in alignment horizontally in the display means and the displayed area changing means can change horizontal positions of displayed areas of the first and the second pictures.

11. A picture file device having recording means for recording a still picture, comprising:
control means having communication means for outputting a control signal to a function unit based on a control signal received by the communication means;
recording operation detecting means for detecting a picture recording operation;
picture recording control means for, when the picture recording operation is detected by the recording operation detecting means, creating a picture file having a first area for storing data of the still picture and a second area for storing first text data relating to the still picture data and for outputting the created picture file to the recording means;
comparison display means for displaying a first picture indicating a current state of a subject and a second picture indicating a past state of the subject, which is read from picture recording means, in alignment at the same time by switching picture switching means; and
displayed area changing means for independently changing displayed area of the first picture and the second picture, which are displayed in the display means.

12. The picture file device according to claim 11, in which the first text data has a string portion including desired characters and number data, further comprising:
first operation processing means for incrementing the number data; and
second operation processing means for incrementing the number data when the picture recording operation is detected.

13. The picture file device according to claim 11, wherein a picture title is held in the picture file and a directory title is held in a file different from the picture file, both of which are displayed instead of the file name and the directory name.

14. The picture file device according to claim 11, where a combination of a picture title and a directory title is held within the picture file and is displayed instead of the file name and the directory name.

15. The picture file device according to claim 13, wherein the picture title includes a string portion to which a desired character can be entered and a serial number portion where a serial number can be entered, the device further comprising operating means for incrementing the serial number portion.

16. The picture file device according to claim 14, wherein the picture title includes a string portion to which a desired character can be entered and a serial number portion where a serial number can be entered, the device further comprising operating means for incrementing the serial number portion.

17. The picture file device according to claim 11, wherein the first picture is a moving picture or a freeze still picture indicating a current state of a subject.

18. The picture file device according to claim 11, wherein the second picture is a moving picture or a still picture.

19. The picture file device according to claim 11, wherein the first picture and the second picture are displayed in alignment horizontally in the display means and the displayed area changing means can change horizontal positions of displayed areas of the first and the second pictures.
